(19) United States
(12) Patent Application Publication
(10) Pub. No.: US 2026/0367938 A1
(43) Pub. Date: Nov. 19, 2026

(54) CONSTRAINT- AND VECTOR ENCODING-BASED INTERFACE CONFIGURATION AND DATA STRUCTURE GENERATION

(71) Applicant: PALO, Inc., Menlo Park, CA (US)

(72) Inventors: Shivam Pankaj Kumar, Mountain View, CA (US); Alastair Deng, Palo Alto, CA (US); Jay Neo, Menlo Park, CA (US)

(21) Appl. No.: 19/316,990

(22) Filed: Sep. 2, 2025

Related U.S. Application Data
(60) Provisional application No. 63/807,470, filed on May 16, 2025.

(51) Int. Cl. G06F 9/451; G06F 3/0482; G06F 3/0484

(52) U.S. Cl. CPC G06F 9/451; G06F 3/0482; G06F 3/0484

(57) ABSTRACT

Systems and methods for configuring and distributing multimedia datasets based on user-dependent analytics, constraints, and user input are disclosed herein. The system can obtain a set of multimedia datasets associated with a first user and generate vector encodings representing the multimedia datasets. The system can receive a set of constraints associated with deploying the multimedia datasets and can generate a GUI enabling user configuration of templates for generating multimedia datasets. The system can generate a multimedia dataset template according to a user selection on the GUI, where the multimedia dataset template is consistent with the set of constraints. The system can generate the template for display on the GUI and receive, in response, a multimedia dataset consistent with the template. The system can transmit the received multimedia dataset to a set of servers, consistent with the set of constraints.

### CROSS-REFERENCE TO RELATED APPLICATIONS

This application claims priority to U.S. Provisional Patent Application No. 63/807,470, filed on May 16, 2025, the disclosure of which is hereby incorporated by reference herein in its entirety.

### BACKGROUND

The continued evolution of multimedia and software development techniques, as well as associated development environments, has been accompanied by a growing diversity of code, metadata, and associated artifacts managed across distributed computing systems. As codebases and deployment pipelines expand in complexity and scale, there is an increasing emphasis on flexible, scalable approaches to handling and integrating heterogeneous data types.

Conventional pipelines and automation workflows relating to code deployment or the creation of complex data structures often operate upon monolithic architectures and segregated processing tools. While conventional systems can integrate artificial intelligence (AI) and machine learning–based solutions to improve the flexibility and efficiency of such development pipelines, existing systems can struggle to support complex input types and data from heterogeneous sources. As pipelines become more distributed and modular, conventional development environments may, in some circumstances, struggle to accommodate increasingly complex development architectures and distribution constraints for proper scalability, efficiency, and accuracy.

### SUMMARY

Many conventional data processing and analytics pipelines (e.g., for developing software applications) can be fragmented and inefficient due to constraints involving input sources, limits on user interaction, and constraints imposed upon generated and transmitted data structures, such as code snippets from a software development pipeline. For example, conventional systems that enable deployment of code and/or associated software applications often rely on fragmented build and deployment data (e.g., including code, build logs, test results, and deployment metadata). As such, leveraging such data to improve system efficiency or accuracy (e.g., in generation of code snippets) can be difficult, as such data can reside in different nodes of cloud-computing servers and/or represent data of different formats.

Moreover, while generative engines, such as generative artificial intelligence (AI) models, enable prompt engineering to generate code or code-related data based on complex requirements informed by complex requirements or data, such engines lack the ability to tailor generated code to particular styles or forms, such as coding styles associated with particular developers. To illustrate, conventional large-language models can be trained on a large corpus of training data, enabling generation of code snippets or other software development components (e.g., data structures) based on a wide array of previous examples, programming languages, frameworks, and software architectures. However, training data in conventional systems can often be associated with various unrelated entities and can lack information relating to coders’ individual preferences, previously generated or deployed code, team-related constraints, regulatory requirements, and/or other suitable data. For example, conventional large-language model implementations can generate components of software applications (e.g., code snippets) that are not compatible with previously generated code or that are not consistent with the best practices, stylistic requirements, or the software development philosophies of a given development pipeline.

While conventional systems can impose technical, regulatory, or other suitable constraints through rules engines or decision trees, such ad-hoc or manual compliance checks can be costly and can be system- or platform-dependent (e.g., depending on the origin of the data associated with the development pipeline or the target deployment location). To illustrate, various distribution endpoints (e.g., locations where code snippets or software applications are to be deployed) can be subject to different constraints (e.g., formats, compliance, timing, and/or security/policy constraints). Conventional data pipelines can lack an integrated mechanism to ingest data from different sources, process such data, and generate suitable data (e.g., code snippets) that are adapted to the different imposed constraints.

Furthermore, pre-determined rules engines, as applied to conventional data processing pipelines, can be overly restrictive as they modify or transform data to comply with any development or regulatory constraints without providing flexibility to the user with respect to how compliance with constraints is achieved. To illustrate, a conventional system may automatically remove or alter elements of a code snippet that are deemed non-compliant with platform-specific or regulatory requirements, without allowing the user to select alternative methods of compliance, such as substituting content. This lack of user control can result in a loss of creative intent (e.g., in problem-solving in software development workflows), suboptimal developer experience, and unnecessary data modification, as the conventional system can enforce rigid compliance rather than enabling user-driven or context-sensitive solutions. As a result, conventional development pipelines and other data processing workflows can provide insufficient adaptability, flexibility, and tailoring with respect to generated and/or deployed data structures (e.g., code snippets or software application-related components to be deployed).

Moreover, many conventional deployment systems can further limit flexibility by automating platform- or persona-specific (e.g., developer- or development team-specific) deployment decisions without offering dynamic or real-time control to developers. In these environments, automated processes frequently make deployment decisions, such as deployment location selection or parameter optimization decisions, without soliciting user input or providing actionable suggestions. This deficit of interactive control can be particularly problematic for developers seeking to optimize deployments based on real-time performance metrics or to impose context-aware customization of generated code snippets or software applications. As such, excessive automation, with limited user supervision, can reduce in-development flexibility and diminish the ability of users to make nuanced decisions that align deployments with evolving objectives or development styles or personas.

In some cases, inputs to the development pipeline originate from disparate sources and arise in a variety of formats, leading to challenges in uniform ingestion, processing, and interoperability of data flows. For example, certain types of data stores in a code generation platform, including target/destination servers and data structures, can include different types of metadata, data storage, syntax, and/or available performance parameters or metrics. For example, a conventional software development flow may not readily accommodate the integration and processing of heterogeneous data types and artifacts originating from distributed sources, often requiring monolithic architectures or segregated tools that lack the flexibility and scalability to support modular, complex development pipelines or evolving distribution constraints.

The application orchestration platform (e.g., the multimedia orchestration platform) disclosed herein enables user-dependent analysis, control, and constraint-driven generation of downstream data structures based on heterogeneous data types and dynamic constraints, thereby alleviating the technical challenges associated with conventional development or data-processing pipelines described above. For example, the application orchestration platform obtains previously deployed multimedia datasets (e.g., code snippets or software applications) associated with a particular user or entity (e.g., a software developer and/or software development team or style) and encodes the data in the form of a first set of vector encodings, thereby encapsulating various attributes associated with the code snippets in a uniform, comparable data format. By labelling and/or encoding data associated with the particular user of the software development pipeline, the application orchestration system enables hyperpersonalized configuration and management of graphical user interfaces, tailored multimedia dataset (e.g., code snippet) generation, and user-specific workflow orchestration.

By doing so, the application orchestration platform enables user- or persona-specific information, as well as other suitable information or attributes associated with the previously deployed code snippets, to be encoded in a uniform, attribute-rich representation. Furthermore, the application orchestration platform can fuse data of different formats or that includes different components by generating a uniform vector encoding in a particular vector encoding space, thereby enabling comparison between different types of objects (e.g., code snippets and compiled software applications) within a unified framework, thereby improving the resilience, flexibility, and data ingestion capabilities of the application orchestration platform.

The application orchestration platform can receive a request for a new multimedia dataset (e.g., a code snippet or software application component) for deployment (e.g., from an administrator system and/or an associated device associated with the pipeline). The request can include a set of constraints associated with the new code snippet, such as regulatory, technical, and/or application-driven constraints. The application orchestration platform can retrieve a second set of vector encodings corresponding to a variety of previously generated data structures (e.g., code snippets or software applications) associated with other software developers, software development teams, or deployment locations (e.g., other entities), thereby enabling analytics of a variety of different development philosophies, code snippet structures, or software application features. As a result, the application orchestration platform enables dynamic, context-aware synthesis and deployment of code snippets or software components by integrating a user’s previous deployed or generated code with other users’ code from a diverse corpus of prior development solutions, thereby facilitating identification and adaptation of code structures that reflect development patterns that have been proven successful in analogous contexts. As such, the disclosed application orchestration platform enables improved insights and analytics that are applicable to new software development tasks, based on previous solutions associated with the particular user and other users.

The application orchestration platform can provide the first set of vector encodings (e.g., corresponding to the particular software developer associated with the pipeline), the second set of vector encodings (e.g., corresponding to a variety of entities or software developers spanning a variety of software development applications or styles), and the set of constraints to a large-language model to generate a user-interface schema that is specific to the particular software developer or orchestration task. The user-interface schema can include options for the user based on the received constraints and previous contextual information associated with both the particular user and other users. The application orchestration platform can generate a user interface that includes components specified within the user-interface schema, thereby enabling the associated software developer (e.g., user) to select an option for generating the requested code snippet that is consistent with the provided constraints but that also is consistent with the user’s software development style, as well as successful iterations of previously generated code snippets associated with other users. To illustrate, the option represented on the GUI can include a suggestion or indication of a particular set of object hierarchies (e.g., in the context of an object-oriented language), a particular syntax style, and/or a particular functionality to include within the code snippet.

The application orchestration platform can receive the user’s selection on the user interface and provide an indication of the selection, the set of constraints, the first set of vector encodings of previously deployed code (e.g., associated with the user), and the second set of vector encodings of previously deployed code (e.g., associated with other users) to a large-language model to generate a code snippet template that is consistent with the constraints and the user’s selection. For example, when the user selects a “network interface object” selection, the application orchestration platform can generate a code snippet framework or template (e.g., a set of guidelines or bullet points) that defines, in an object-oriented programming language, a network interface object. In some implementations, the application orchestration platform generates the full code snippet.

The application orchestration platform can present the generated template or code snippet on the user interface, thereby enabling the user to generate an associated code snippet and/or modify the provided code snippet (and/or compile the associated code as needed). The user can provide the generated or modified code snippet to the application orchestration platform for transmission (e.g., deployment) to any suitable locations (e.g., servers). In some implementations, the application orchestration platform can modify the code snippet provided by the user (e.g., by compiling it or integrating it into a software application) prior to deployment.

The inventors have also developed a system for dynamically configuring and managing multimedia content workflows (e.g., software development workflows) by leveraging performance metrics associated with previously deployed code snippets or software applications while enabling performance metric analytics-informed and target location-constrained deployment of data structures, such as code snippets or associated software applications. For example, the application orchestration platform (e.g., the multimedia orchestration platform) disclosed herein obtains a new multimedia dataset (e.g., a code snippet) that is associated with a particular user (e.g., a software developer) and/or associated user profile. To illustrate, a particular user or software developer can include different personas corresponding to different coding styles or philosophies (e.g., associated with different development teams or applications).

The application orchestration platform can provide the code snippet to a large-language model to generate a vector encoding that encapsulates data associated with the new code snippet to enable comparison and analysis with respect to other, previously generated code snippets or application deployments, thereby providing an attribute-representation of the multimedia dataset. As an illustrative example, the application orchestration platform retrieves a performance-metric dataset associated with previously deployed code snippets (e.g., including information relating to any compilation errors, bugs, or traffic associated with usage of the associated software application), as well as associated performance-metric values and platform identifiers that indicate the associated deployment location. These previously deployed code snippets can be associated with different deployment locations, thereby providing deployment location–specific analytics (e.g., server- or platform-specific analytics) to guide further platform-tailored development tasks (e.g., further multimedia dataset transmissions).

The application orchestration platform can generate a set of vector encodings representing attributes of the retrieved, previously deployed code snippets, including information relating to their performance metric values and/or platform identifiers. By doing so, the application orchestration platform enables platform-specific and performance-aware analysis and encoding of complex, heterogeneous multimedia datasets (e.g., different deployed code snippets, compiled code, software applications, or associated graphical user interfaces) in a unified form, while encapsulating information relating to their performance (e.g., in their deployed state) to aid in further tailoring, development, and configuration of code snippets and/or applications.

The application orchestration platform can generate a user interface schema, including interface elements, that include a set of options, selections, or user controls, thereby enabling users of the application orchestration platform to select, configure, and/or modify possible pipeline outputs (e.g., in a platform-specific, persona-specific, or constraint-specific manner). For example, the user interface schema can include one or more indications of platform-specific (e.g., deployment location–specific) suggestions based on code snippet performance on a particular platform. As an illustrative example, the application orchestration platform generates, for display on the user interface, an indication of a suggested programming language for a particular deployment location (e.g., that supports compilations of that particular programming language), while the application orchestration platform can generate an indication of another suggested programming language for a different deployment location. By doing so, the application orchestration platform can guide, support, and/or execute the modification of newly created multimedia datasets (e.g., code snippets) based on associated constraints (e.g., performance-related or otherwise) in a platform-dependent and/or user-dependent manner.

To illustrate, the application orchestration platform can receive an indication of a user interaction associated with the one or more interface elements of the set of interface elements, along with any transmission constraints associated with the interface elements. The user interaction can include an indication of a selected programming language for a particular platform (e.g., according to one of the suggestions on the graphical user interface). Based on the user interaction, the application orchestration platform can (e.g., via a large-language model) modify the multimedia dataset (e.g., modify the code snippet) to conform to the suggestion (e.g., to conform to the selected or suggested programming language). Subsequently, the application orchestration platform can transmit the modified code snippet (e.g., the modified multimedia dataset) to one or more servers (e.g., distribution locations) according to the user’s interaction with the GUI, thereby enabling adaptive, flexible, performance-sensitive modification and distribution of suitable data structures (e.g., code snippets or other multimedia datasets) to associated platforms, servers, or deployment locations.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### BRIEF DESCRIPTION OF THE DRAWINGS

FIG. 1 shows an illustrative environment for orchestrating the analysis, generation, modification, and distribution of multimedia data in a user-sensitive, platform-sensitive, and constraint-sensitive manner, in accordance with one or more implementations of the disclosed technology.

FIG. 2 shows a block diagram of an example transformer, in accordance with one or more implementations of the disclosed technology.

FIG. 3 shows a block diagram of a framework for configuring and distributing multimedia datasets based on user-dependent analytics, constraints, and user input, in accordance with one or more implementations of the disclosed technology.

FIG. 4A shows a schematic of a GUI enabling selection of multimedia dataset templates, in accordance with one or more implementations of the disclosed technology.

FIG. 4B shows a schematic of a GUI enabling tuning of multimedia dataset templates, in accordance with one or more implementations of the disclosed technology.

FIG. 5 shows a flow diagram illustrating a process for generating a multimedia dataset template based on a user input associated with user-specific multimedia dataset analytics, in accordance with one or more implementations of the disclosed technology.

FIG. 6 shows a block diagram of a framework for configuring, modifying, and distributing multimedia datasets in a platform-dependent, performance-sensitive, and user input–driven data processing flow, in accordance with one or more implementations of the disclosed technology.

FIG. 7A shows a schematic of a GUI enabling display of and interaction with performance metric data associated with platform-specific and/or entity-specific multimedia datasets, in accordance with one or more implementations of the disclosed technology.

FIG. 7B shows a schematic of a GUI enabling multimedia dataset–level display and interaction with entity-specific analytics, in accordance with one or more implementations of the disclosed technology.

FIG. 8 shows a flow diagram illustrating a process for configuring and modifying a multimedia dataset based on performance metric– and user-based analytics for distinct platforms or servers, in accordance with one or more implementations of the disclosed technology.

FIG. 9 is a block diagram that illustrates an example of a computer system 900 in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The multimedia orchestration platform disclosed herein enables content creator-dependent analysis, control, and constraint-driven generation of downstream content (e.g., associated with social media platforms) based on heterogeneous media types (e.g., video, image, audio, text, comments, likes, and/or other suitable metadata) and dynamic publishing constraints (e.g., associated with advertising).

For example, the multimedia orchestration platform can ingest previously published multimedia datasets, including media assets associated with a particular creator or entity (e.g., an individual creator, a creative team, and/or a branded persona), and can encode the multimedia datasets within a first set of vector embeddings using a large-language model, thereby encapsulating diverse media attributes, such as genre, style, audience interaction metrics, and compliance requirements or flags, in a unified, comparable digital format. By labeling or encoding multimedia datasets based on characteristics of a particular creator or persona, the system can integrate persona-specific attributes, styles, and/or historical data into a uniform, attribute-rich vector representation. As such, the architecture of the multimedia orchestration platform can improve the resilience, agility, and data ingestion adaptability of content generation workflows.

The system can receive a request to generate, edit, and/or publish a new content item (e.g., a video, image post, podcast, or other suitable data), such as from a device associated with an advertising sponsor or other suitable requester (e.g., a fan). The request can specify a set of constraints, such as requirements, limitations, or guidelines associated with platform or sponsor-related instructions. For example, the constraints can include publishing constraints associated with social-media platform–specific policies, copyright, regulatory requirements (e.g., filters for not-safe-for-work content) and/or audience targeting instructions. As such, the system enables flexible integration and sensitivity to technical and/or stylistic constraints imposed by third parties, while providing for user creativity and control within such constraints.

In some implementations, the system provides a user interface and associated functionality for personalization of advertisement or sponsorship parameters (e.g., prices, types of promotions or sponsorships, or other suitable information). For example, the system provides an interface for creators to select sponsorship deals (e.g., types of advertisements or promotions, such as product placement, mentions, and/or other advertising methods) with pricing that is dependent on the creator’s historical content items (e.g., videos, image posts, podcasts, and/or other suitable data). To illustrate, the system calculates a relatively high price value for a particular product placement offer by a first advertiser for a more prolific content creator (e.g., associated with more engagement-heavy metadata, such as a number of positive comments, likes, or re-posts within a given platform or set of platforms), while the system calculates a relatively low price value for an analogous product placement offer for relatively less prolific content creator (e.g., associated with less engagement-heavy metadata, such as a fewer number of positive comments, likes, or re-posts). The system can display the calculated price values on the respective content creators’ user interfaces, thereby enabling personalized statistics-dependent facilitation of sponsorship and advertising within the platform.

The system can retrieve a second set of vector encodings representing multimedia datasets (e.g., social media content) associated with other creators, personas, affiliated brands, external sources, or content creation teams (e.g., associated with other social media influencers). By retrieving such data, the platform enables advanced analytics across diverse creator communities, content styles, formats, and channels strategies, thereby enabling dynamic, context-aware adaptation and distribution of media. For example, by doing so, the multimedia orchestration platform can integrate the creator’s own content with other creators’ previously published content, thereby facilitating the identification and leveraging of high-performing content structures or templates (e.g., subject to dynamic trends), while enabling the content creator (e.g., the user) to conform to their own style, genre, or preferences.

The multimedia orchestration platform can input the first set of vector encodings (e.g., representing the creator’s past multimedia datasets), the second set of vector encodings (e.g., representing aggregated multimedia datasets associated with other creators, peers, and/or the community), and constraints (e.g., associated with advertising policies or guidelines) to a large-language model to generate a tailored user interface schema for the creator. For example, the user interface schema can include suggested authoring or publishing tasks (e.g., that are consistent with the provided constraints, the creator’s publishing history, and/or social media trends). For example, the user interface schema can include indications of GUI elements (e.g., tiles, buttons, descriptors, drop-down menus, etc.) that enable a user (e.g., a creator) to select a video format (e.g., a “reaction video” format) according to the ingested data. For example, in some implementations, the user interface schema includes suggested lyrics, transcripts, captions, or storyboards associated with suggested content (e.g., in accordance with associated constraints).

The multimedia orchestration platform can present the generated information on the GUI according to the generated user interface schema to enable the user to interact with the interface. For example, the creator can interact, via user controls associated with the GUI, with various generated content creation ideas. For example, the creator can refine, adapt, and/or generate the selected or suggested media dataset using the interface. For example, the platform receives a selection of a first user control of the GUI (e.g., corresponding to the “reaction video” format). In response to the selection, the platform can generate, for display on the user interface, a suggestion for a video to which the creator is to react, as well as a suggested script and/or product placement instructions. The multimedia orchestration platform can receive, from the user (e.g., via an “upload” interface), the creator’s video associated with the selection, thereby enabling transmission of the generated media content to any suitable media platforms (e.g., via a selection interface). For example, the orchestration platform can apply final transformations (e.g., re-encoding, tagging, and/or content optimization) for each destination channel (e.g., servers associated with social media platforms), thereby enabling user-tuned, constraint-sensitive configuration and distribution of social media-based multimedia datasets.

In some implementations, the multimedia orchestration platform disclosed herein enables dynamic configuration and managing of multimedia datasets (e.g., associated with social media content) based on creator-specific and/or community-wide performance metrics and engagement analytics from previously published multimedia datasets, thereby enabling the understanding, refinement, and/or automation of publishing operations. For example, the multimedia orchestration system can identify and apply performance-driven adaptations (e.g., changing a video introduction length or thumbnail style) based on a particular platform (e.g., an associated audience), an audience segment, and/or shifting trends.

The multimedia orchestration platform can generate vector encodings of new or candidate multimedia datasets, such as proposed videos or descriptions thereof by a creator for potential distribution to a variety of platforms. For example, the vector encodings can encapsulate attributes associated with style, topic, and/or predicted engagement associated with the associated multimedia dataset. Additionally or alternatively, the multimedia orchestration platform retrieves historical analytic datasets (e.g., and/or vector encodings thereof) associated with previously generated multimedia datasets (e.g., previously uploaded content by the creator and/or other creators), as well as the associated publication channels. The multimedia orchestration platform can generate vector encodings representing the historical datasets, thereby encapsulate information associated with performance metric values (e.g., engagement metrics) associated with the corresponding videos, as well as publishing channel–specific information. For example, the generated vector encodings capture social media platform–sensitive performance information to inform generation of subsequent multimedia datasets (e.g., creator content).

The multimedia orchestration platform can provide the vector encoding corresponding to the new multimedia dataset (e.g., the candidate video or social media post), set of vector encodings and associated performance metric data to the large-language model to generate a user-interface schema providing the user with control over modification and/or dissemination of the dataset according to any user-specific, platform-specific, persona-specific, or trend-specific information, thereby enabling the creator to select how to disseminate the video (e.g., whether to share the multimedia dataset to particular platforms and with any associated restrictions). In some implementations, the user interface includes analytics (e.g., specific to the platform), including analytics information relating to reach, viewership, and/or other suitable performance metric information. The multimedia orchestration platform can generate the GUI consistent with the user-interface schema.

The creator can interact with the GUI, thereby specifying particular constraints, confirming actions, and/or otherwise providing instructions to modify the multimedia dataset or associated publication parameters. For example, the multimedia orchestration platform can receive an indication of a user-selected publishing schedule, persona-channel linkage, and/or set of constraints associated with particular platforms. In response, the multimedia orchestration platform can modify the provided multimedia dataset (e.g., the suggested video) in accordance with the user-selected attributes, thereby further refining the associated multimedia dataset with respect to the creator’s intent, target audiences, and platform requirements. As such, the multimedia orchestration platform can deliver adaptive, high-performance, multi-platform content orchestration in a constraint-sensitive, trend-sensitive, hyperpersonalized manner.

In some implementations, the multimedia orchestration platform provides an integrated suite of modules leveraging artificial intelligence, such as large language models (LLMs), for end-to-end automation and optimization of digital content creation, analytics, and distribution. A Scope module can analyze content from competitors and trending media across platforms, ingesting multi-modal data, generating vector representations, and applying hierarchical topic modeling with dimensionality reduction to surface trends and niche opportunities. The module enables strategic content planning through advanced clustering and slicing of content data and dynamic construction of content hierarchies.

A Publish module can automate generation and adaptation of content for cross-platform distribution. Artificial intelligence–driven captioning can be performed based on historical channel data and platform-specific requirements. The module can incorporate automated translation of both video and textual metadata, and performs video analysis for advertising compliance, filtering content against advertiser and platform standards. The multimedia orchestration platform can generate optimal publishing times and cross-platform scheduling recommendations based on engagement analytics and audience segmentation, facilitating streamlined multi-platform profile migration and dissemination.

An Ideate module can offer both rapid and in-depth ideation modes, employing LLM-based channel analytics, topic similarity searches within a vector database, and tunable topic selection interfaces (such as adjustable similarity threshold controls) to identify trending or relevant topics. The Ideate module can transition selected ideas into script-ready formats, enabling efficient and data-driven content development pathways.

A Write module can provide a collaborative editing interface in which multiple users can contribute to script development in real time. Driven by a pipeline of at least two LLMs—one for generating candidate prompts, hooks, or narrative structures based on sample videos, and another for evaluating and ranking such content—the module can iteratively refine scripts to enhance content engagement through tension, pacing, and alignment with proven content strategies.

An Edit module can introduce natural language-based video editing, enabling users to perform editing operations via plain-language inputs and supporting automated or agentic tool selection and integration. This module supports modular reconfiguration of editing tools based on LLM interpretation and can automate the detection of new videos matching existing scripts, queuing them for further editing or publishing. Collectively, these modules enable hyperpersonalized, analytics-driven, and automated content lifecycle management across platforms.

### Overview of the Multimedia Orchestration Platform

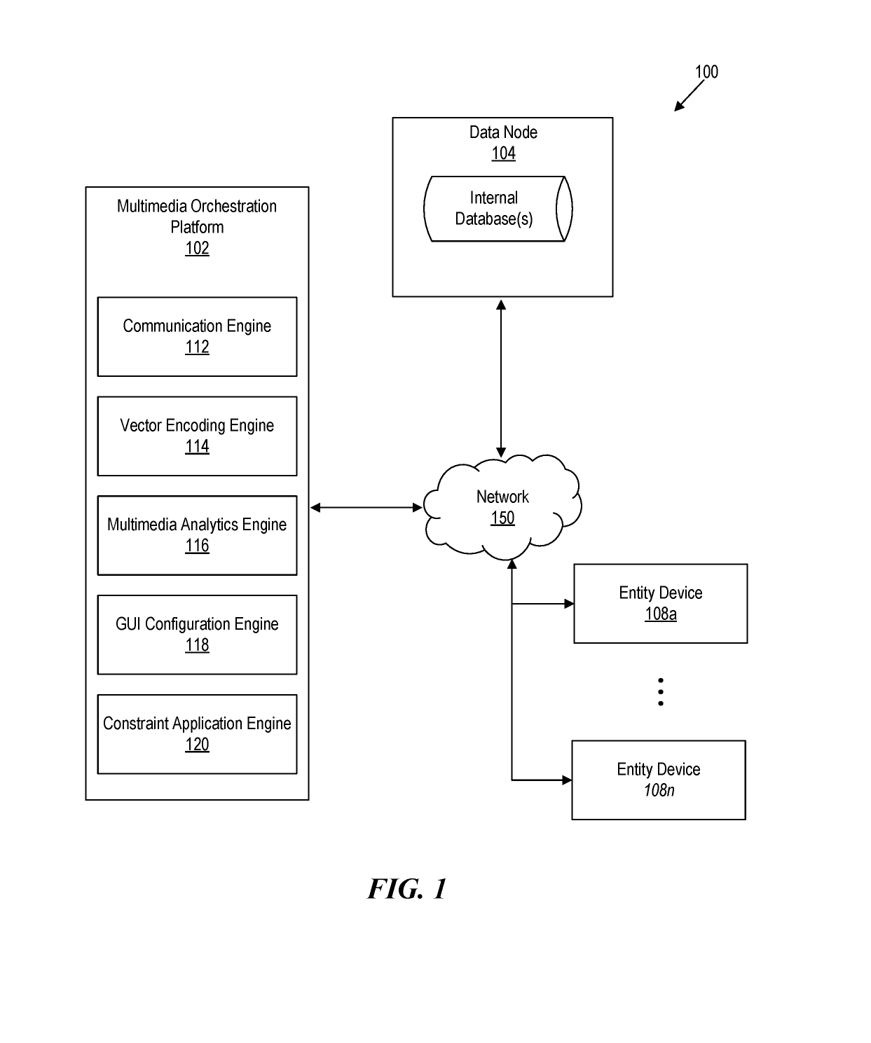

FIG. 1 shows an illustrative environment 100 for orchestrating the analysis, generation, modification, and distribution of multimedia data in a user-sensitive, platform-sensitive, and constraint-sensitive manner, in accordance with one or more implementations of the disclosed technology.

For example, the environment 100 includes multimedia orchestration platform 102, capable of communicating with (e.g., transmitting or receiving data to or from) a data node 104 and/or entity devices 108a-108n via a network 150. Multimedia orchestration platform 102 can include software components, hardware components, or a combination of both and can reside on a physical server or a virtual server running on a physical computer system. For example, multimedia orchestration platform 102 can be distributed across various nodes, devices, or virtual machines (e.g., as in a distributed cloud server). In some implementations, multimedia orchestration platform 102 is configured on a user device (e.g., a laptop, computer, smartphone, desktop computer, electronic tablet, or another suitable user device). Additionally or alternatively, multimedia orchestration platform 102 can reside on a server or node and/or can interface with one or more entity devices 108a-108n directly or indirectly. The multimedia orchestration platform 102 can include one or more subsystems or subcomponents. For example, the multimedia orchestration platform 102 includes a communication engine 112, a vector encoding engine 114, a multimedia analytics engine 116, a GUI configuration engine 118, and/or a constraint application engine 120.

The multimedia orchestration platform 102 can receive inputs (e.g., prompts, multimedia datasets, and/or indications of user interactions with a GUI) and/or other suitable data from one or more devices, servers, or systems. The multimedia orchestration platform 102 can receive such data using communication engine 112, which can include software components, hardware components, or a combination of both. For example, the communication engine 112 includes or interfaces with a network card (e.g., a wireless network card and/or a wired network card) that is associated with software to drive the card and enables communication with network 150. In some implementations, the communication engine 112 can also receive data from and/or communicate with the data node 104, or another computing device. The communication engine 112 can communicate with the vector encoding engine 114, the multimedia analytics engine 116, the GUI configuration engine 118, and the constraint application engine 120, and/or other devices associated with the environment 100.

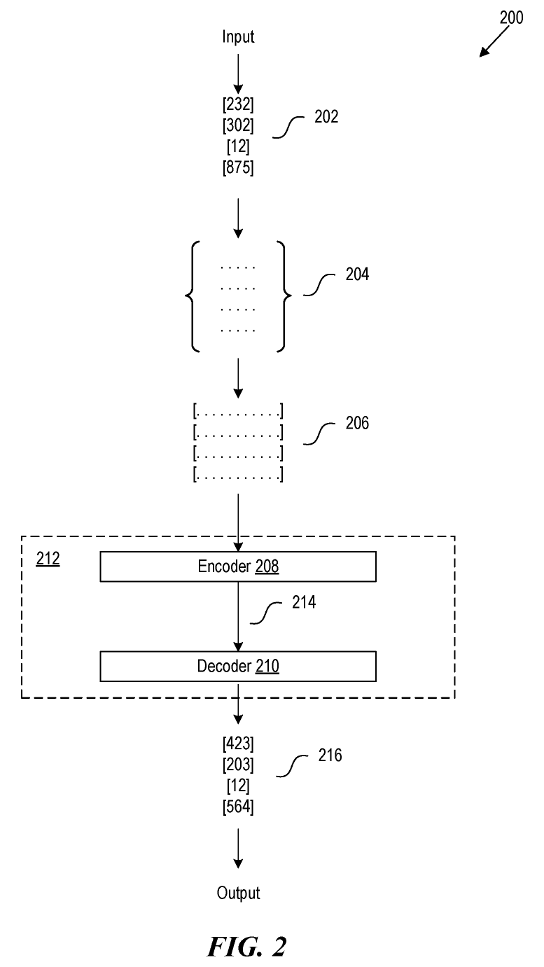

In some implementations, the multimedia orchestration platform 102 can include the vector encoding engine 114. The vector encoding engine 114 can perform tasks associated with vector encoding (e.g., encapsulation or embedding of information associated with multimedia datasets, performance metric values, profile or persona data, and/or other suitable data). For example, the vector encoding engine 114 receives a new multimedia dataset (e.g., a video) associated with an entity and generates a vector encoding representing semantic, thematic, and/or metadata associated with the multimedia dataset, such as via a large-language model (e.g., as described in relation to FIG. 2). The vector encoding engine 114 can include software components, hardware components, or a combination of both. For example, the vector encoding engine 114 includes one or more hardware components (e.g., processors) that are able to execute operations for encoding vectors, generating a vector space, and/or ingesting heterogeneous data structures. The vector encoding engine 114 can directly or indirectly communicate data with systems or nodes associated with the entity devices 108a-108n and/or data node 104. Additionally or alternatively, the vector encoding engine 114 receives data and/or sends data from the communication engine 112, the multimedia analytics engine 116, the GUI configuration engine 118 and/or the constraint application engine 120.

The multimedia analytics engine 116 can execute tasks relating to analysis and interpretation of multimedia datasets and associated data (e.g., across multiple platforms and entities). In some implementations, the multimedia analytics engine 116 is configured to extract performance-metric values, content metadata, and/or engagement statistics from multimedia datasets and/or associated vector encodings received via platform APIs or entity devices. The multimedia analytics engine 116 can leverage large-language models and/or other AI-based analytical tools to generate, compare, or analyze (e.g., determine patterns associated with) feature vectors, performance-metric values, and/or content labels (e.g., associated vector encodings) for multimedia datasets. To illustrate, the multimedia analytics engine 116 incorporates submodules for video frame analysis (e.g., object and activity recognition), audio analysis (e.g., speech-to-text, sentiment extraction), and metadata parsing (e.g., extraction of engagement metric data or trend data). The multimedia analytics engine 116 can include software components (e.g., large-language models, artificial intelligence engines, statistical inference tools, and/or other suitable components), hardware components, and/or a combination of both. The multimedia analytics engine 116 can communicate with the communication engine 112, the vector encoding engine 114, the GUI configuration engine 118, the constraint application engine 120, and/or other components associated with the network 150 (e.g., the data node 104 and/or the entity devices 108a-108n).

The GUI configuration engine 118 can execute tasks relating to generating user-interface schemas and/or causing/generating GUIs associated with the user-interface schemas. For example, the GUI configuration engine 118 includes software components (e.g., configurable UI generation modules or associated large-language models, and/or platform-specific schemas), hardware components, or a combination of both. As an illustrative example, the GUI configuration engine 118 is configured to receive engagement- or performance-related data, vector encodings, entity-related data (e.g., profile-related data), and/or associated information from the vector encoding engine 114, the multimedia analytics engine 116, the communication engine 112, and/or the constraint application engine 120. For example, the GUI configuration engine 118 dynamically generates or updates user interface schemas determining the arrangement, labelling, and interactive elements of a GUI (e.g., associated with the entity devices 108a-108n). The GUI configuration engine 118 can support modular user-interface components (e.g., selectable interface elements, dashboards, and/or analytic visualizations). The GUI configuration engine 118 can communicate with the communication engine 112, the vector encoding engine 114, the multimedia analytics engine 116, the constraint application engine 120, the data node 104, the network 150, the entity devices 108a-108n, and/or other associated devices (e.g., via the network 150).

The constraint application engine 120 can execute tasks relating to applying constraints (e.g., requirements, suggestions, policies, and/or security protocols) to multimedia datasets and/or related processes thereof. The constraint application engine 120 can include software components (e.g., constraint generation modules, compliance verification modules, and/or rule-based models), hardware components, or a combination of both. For example, the constraint application engine 120 can receive (e.g., from the communication engine 112, the vector encoding engine 114, the multimedia analytics engine 116, and/or the GUI configuration engine 118) information associated with platform- or persona-specific rules (e.g., constraints), including forbidden elements, publication times, file size restrictions, and/or other suitable data. The constraint application engine 120 can communicate with the communication engine 112, the vector encoding engine 114, the multimedia analytics engine 116, the GUI configuration engine 118, the data node 104, the network 150, the entity devices 108a-108n, and/or other associated devices (e.g., via the network 150).

The data node 104 can store various data, including one or more machine learning models, multimedia datasets, prompts, representations of multimedia datasets, graphical user interface templates, vector embeddings, performance metric data, and/or other suitable information. For example, the data node 104 includes one or more databases, such as an encoding database and/or a multimedia database (e.g., a database for storage of multimedia datasets and/or associated vector encodings, performance metric values, or other suitable multimedia-related information).

The one or more entity devices 108a-108n can correspond to one or more servers, user devices, and/or other associate devices. In some implementations, an entity device includes a device associated with an entity, such as a user and/or a creator. For example, an entity device includes a computing device operated by a content creator for generating, editing, and/or managing multimedia data or by a software developer for generating, editing, and/or managing code snippets or other associated data. In some implementations, an entity device includes a computing device associated with a third-party (e.g., an administrator in a coding pipeline, a brand manager associated with a content creator, and/or a client system), such as a client system used to specify particular constraints (e.g., advertising campaign requirements or restrictions) or to review and approve multimedia content subject to particular constraints (e.g., requirements for advertisement suitability or brand safety).

Additionally or alternatively, an entity device includes one or more servers or systems associated with a third-party platform (e.g., a social media platform) or service provider, such as a content distribution network server, a software deployment endpoint, and/or a social media server. In various examples, an entity device can include, but is not limited to, a desktop computer, laptop, smartphone, tablet, wearable device, or any other suitable computing or network-enabled device, regardless of form factor, supporting one or more operations described herein.

In some implementations, entity devices, such as servers, endpoints, and user devices, can be accessed by the multimedia orchestration platform 102 (e.g., via the communication engine 112), using one or more communication mechanisms. For example, server endpoints or devices are accessible or integrated via application programming interface (API) calls, such as RESTful APIs, GraphQL endpoints, WebSocket connections, gRPC, server-sent event (SSE) connections, or direct socket interfaces), or by other suitable network-based or direct communication protocols.

Engines, subsystems, or other components of the multimedia orchestration platform 102 described herein are illustrative. As such, operations, subcomponents, or other aspects of particular subsystems of the multimedia orchestration platform 102 can be distributed, varied, or modified across other engines. In some implementations, particular engines can be deprecated, added, or removed. For example, operations associated with encoding vectors are performed at the multimedia analytics engine 116 (e.g., or any other suitable engine) instead of the vector encoding engine 114.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create hyperpersonalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 212 includes an encoder 208 (which can comprise one or more encoder layers/blocks connected in series) and a decoder 210 (which can comprise one or more decoder layers/blocks connected in series). Generally, the encoder 208 and the decoder 210 each include a plurality of neural network layers, at least one of which can be a self-attention layer. The parameters of the neural network layers can be referred to as the parameters of the language model.

The transformer 212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer 212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for simplicity. In general, the token sequence that is inputted to the transformer 212 can be of any length up to a maximum length defined based on the dimensions of the transformer 212. Each token 202 in the token sequence is converted into an embedding vector 206 (also referred to simply as an embedding 206). An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some examples, the numerical value of the token 202 can be used to look up the corresponding embedding in an embedding matrix 204 (which can be learned during training of the transformer 212).

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. Additionally or alternatively, the generated embeddings 206 can include sparse embeddings (e.g., BGE or SPLADE embeddings). The disclosed multimedia orchestration platorm can leverage hybrid retrieval (e.g., of dense and/or of sparse embeddings) to improve the embedding of lexical information. The numerical weight of each element in a feature vector 214 represents the importance of the corresponding feature. The space of all possible feature vectors 214 that can be generated by the encoder 208 can be referred to as the latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 is able to generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some examples, the input provided to the transformer 212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs. In some implementations, ChatGPT can receive further instructions (e.g., chat-like inputs) that enable subsequent generaiton of fine-tuned chat-like outputs in an iterative manner.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Multimedia Orchestration Platform for Generating Templates Given Constraints

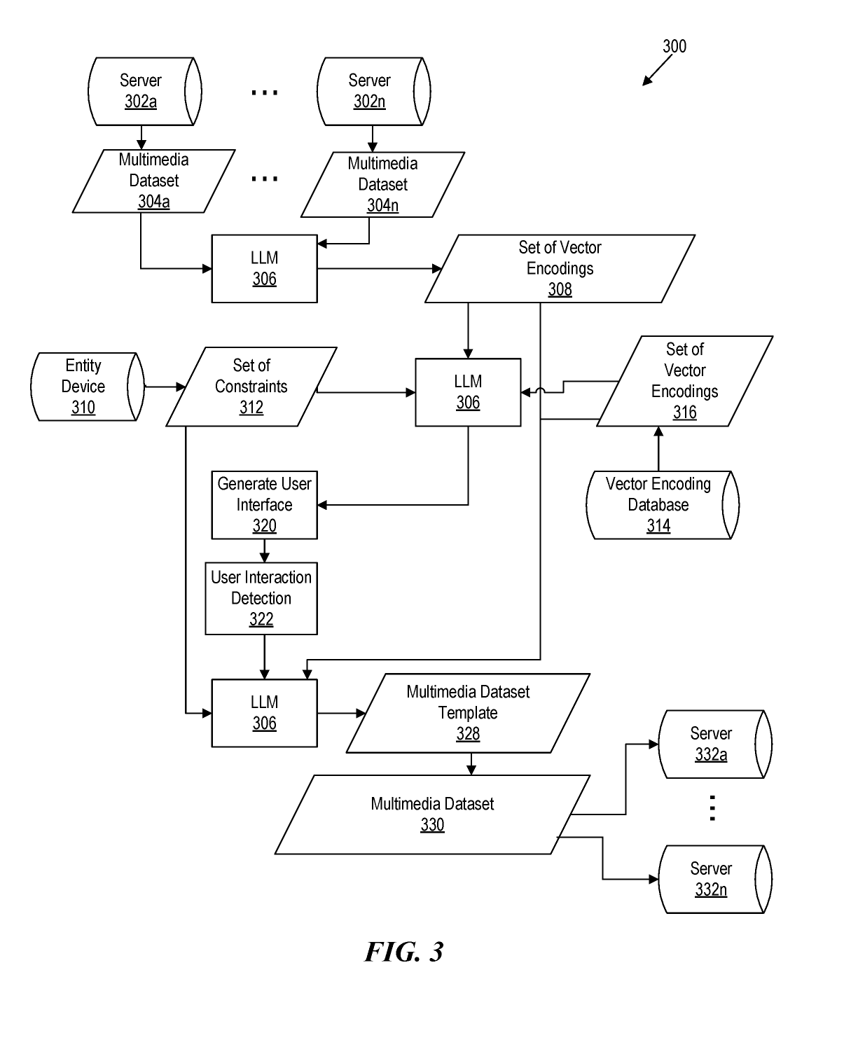

FIG. 3 shows a block diagram of a framework 300 for configuring and distributing multimedia datasets based on user-dependent analytics, constraints, and user input, in accordance with one or more implementations of the disclosed technology. For example, the framework 300 enables generation of multimedia dataset templates according to technical constraints associated with an entity device and/or third-party policies, while enabling user control of workflows via an interactive GUI.

The multimedia orchestration platform 102, via the communication engine 112, can obtain one or more multimedia datasets (e.g., multimedia datasets 304a-304n) from one or more servers (e.g., servers 302a-302n). A multimedia dataset can include video files, audio files, images, or other digital content, associated metadata, comments, engagement metric data, and/or other suitable data. For example, a multimedia dataset includes raw multimedia content (e.g., a recorded video), metadata (e.g., including a title, description, tags, captions, thumbnails, platform identifiers of an associated social media platform / server, entity details (e.g., creator details), creation timestamps, audience labels, and/or discretionary labels (e.g., associated with mature or age-restricted content).

A multimedia dataset can include engagement metrics (e.g., number of views, likes, shares, reposts, comments, a sentiment analysis of engagement with the multimedia dataset on one or more platforms), performance analytics (e.g., retention statistics, and click-through rates), and platform-specific compliance or suitability labels. In some implementations, a multimedia dataset includes digital artifacts, including code snippets, project files, configuration data, and/or other suitable software pipeline-related data. In some implementations, the set of multimedia datasets obtained is associated with a first entity (e.g., a first creator, user, and/or team) associated with a first entity device, and/or a corresponding entity identifier.

An entity can include a user, a creator, an advertiser, a platform, and/or associated personas or profiles. A persona (e.g., a profile) can refer to a logical or data representation of an entity within the system. For example, a persona can include attributes including a creator’s unique name or handle, audience targeting preferences, publishing history, social media accounts, engagement analytics, and/or brand associations. In some implementations, a particular user can be associated with one or more personas/profiles. Additionally or alternatively, a particular user or persona can be associated with one or more platforms (e.g., a single persona can be shared across various platforms). Additionally or alternatively, a platform can be associated with one or more entities (e.g., personas) associated with the same user.

An entity can be associated with an entity identifier, including an alphanumeric string, database key, platform-assigned user identifier, username, handle, a globally unique identifier, hashed token, an account number, and/or another suitable data structure. An entity identifier can be unique and persistent (e.g., assigned by a server, platform, or third-party service), or can be transient or context-specific (e.g., associated with temporary collaborations, guest accounts, or team-members’ accounts). Entity identifiers can include account identifiers associated on content distribution sites (e.g., social media platforms or associated servers), such as channel identifiers, handles, or user identifiers.

Referring to FIG. 3, the multimedia orchestration platform 102 (e.g., via the vector encoding engine 114) can provide the first set of multimedia datasets (e.g., multimedia datasets 304a-304n) to a large-language model 306 to generate a first set of vector encodings 308. For example, the multimedia orchestration platform 102 can retrieve a set of videos recently uploaded by a content creator (e.g., the first entity) managing a multi-platform campaign. Each video can include metadata, including a title, description, caption, set of comments, and/or engagement metric values. For example, the vector encoding engine 114 can receive the multimedia datasets and generate (e.g., via the large-language model 306), an associated high-dimensional vector representation (e.g., a vector encoding).

A vector encoding can include, for a given multimedia dataset, a high-dimensional vector representation encoding information such as semantic features (e.g., extracted from a transcript of the video, the title, and/or associated description). In some implementations, the vector encoding represents structural attributes of the multimedia dataset, such as a duration, file-format, video composition, and/or similar suitable data. The vector encoding can include visual and/or audio signal features, including shapes, colors, patterns, textures, mood analysis, speech analysis, and/or other suitable data. In some implementations, the vector encoding can include frame-by-frame representations of information. Additionally or alternatively, a vector encoding includes engagement and/or audience analytics (e.g., normalized vectors including view counts, watch completion rates, like/dislike ratios, comments, and/or share patterns or maps). In some implementations, the vector encoding includes creator and channel (e.g., persona/profile) identifiers, intended audience labels, demographic vectors (e.g., encapsulating audiences’ or creators’ demographic information), detected languages, and/or platform-specific context tags. The vector encoding can include a representation of temporal signals (e.g., a publication time, a posting frequency, etc.), and/or links to related multimedia datasets or prior uploads.

The multimedia orchestration platform 102 (e.g., via the communication engine 112) can receive a multimedia dataset request associated with a second entity (e.g., an advertising-related entity or brand manager associated with an entity device 310). For example, the multimedia dataset request includes a request for generation of a multimedia dataset according to a set of constraints 312. The set of constraints can include advertiser-specific requirements (e.g., relating to content suitability and/or brand safety), such as forbidden elements (e.g., prohibitions on particular words or topics, such as violence, explicit language, political topics, etc.), mandatory and/or disallowed product placement parameters, platform-related policies, a set of allowed platforms, and/or thresholds for engagement metric values (e.g., a minimum average watch duration and/or specific audience demographic attributes). Constraints can include technical requirements associated with multimedia dataset formats and can be determined, received, and/or generated in the form of structured data, such as a JSON schema.

In response to the multimedia dataset request, the multimedia orchestration platform 102 (e.g., via the communication engine 112 and from the data node 104) can retrieve, from a vector encoding database 314, a second set of vector encodings 316 that correspond to a set of entity identifiers (e.g., other than the first entity). For example, the multimedia orchestration platform 102 can access the vector encoding database 314 to retrieve high-dimensional vector embeddings (e.g., generated by the large-language model) encapsulating information associated with multimedia datasets of other entities (e.g., other content creators, organizations, campaigns, profiles, and/or teams). For example, the second set of vector embeddings can be associated with engagement metric information and/or other suitable information (e.g., as discussed with respect to the first set of vector encodings 308). By doing so, the multimedia orchestration platform 102 enables downstream analytics and comparisons between previously published or transmitted multimedia datasets (e.g., previous videos published by other creators) and the current creator’s previous publications (e.g., by comparing latent semantic similarities or via other axes/projections of the high-dimensional encodings), thereby enabling analysis of current trends in a user-personalized or tailored manner.

The vector encoding database 314 can include a collection of vector encodings representing various multimedia datasets (e.g., each associated with particular entity identifiers, platform identifiers, and/or performance-metric values). The vector encodings can be generated using a large-language model (e.g., the large-language model 306), enabling generation of quantitative representations (e.g., vector embeddings) capturing the characteristics, content, and/or metadata associated with multimedia datasets. In some implementations, the vector encoding database 314 includes vector encodings and associated metadata (e.g., user identifiers, multimedia dataset identifiers, platform information, timestamps, and/or performance metrics (e.g., engagement metric data, including views, likes, shares and/or downloads). Additionally or alternatively, metadata information is encapsulated and/or represented within the corresponding vector encodings.

Referring to FIG. 3, the multimedia orchestration platform 102 can provide the first set of vector encodings 308, the second set of vector encodings 316, and the set of constraints 312 to the large-language model 306 to generate a user-interface schema.

For example, the user-interface schema can include specifications of user interface elements enabling selection of options for the first entity (e.g., the user or content creator) based on received constraints and previous multimedia dataset information (e.g., associated with the first entity or other entities of the set of entities). In some implementations, the user-interface schema includes indications (e.g., pixel positions, and associated attributes) of user interface controls and configurations (e.g., associated with buttons, text boxes, tiles, and/or other associated information) that are dynamically generated based on the vector encodings, the constraints, and profile information (e.g., associated with the first entity). For example, the multimedia orchestration platform 102 can receive (e.g., via the communication engine 112 and/or via the data node 104) profile metadata from a profile database including a set of profile attributes that characterize the profile of the first entity (e.g., the content creator). Based on the profile attributes, the multimedia orchestration platform 102 can configure an associated user-interface schema (e.g., via the GUI configuration engine 118). To illustrate, profile attributes can include user preferences, demographic data, content-creation history, platform or channel associations, engagement metric values, and/or content style indicators.

The profile metadata can be provided to a large-language model, which, in conjunction with prior multimedia dataset information (e.g., associated with the first entity and/or other entities), enables generation of a tailored user-interface schema for the first entity. The schema can specify graphical elements, such as selectable content templates, constraint-driven publication options, predictive content recommendations, and/or visualization modules aligned with the entity’s historical activity and platform requirements.

To illustrate, the graphical elements and/or selectable content templates can include timestamps (e.g., suggesting publication times based on the constraints received from the second entity), sample or proposed scripts for new multimedia templates (e.g., associated with videos and/or other social media content), platform-adaptive formatting elements tailored to the requirements of specific distribution platforms, and selectable visual overlays or watermarks. The user-interface schema and associated generated GUI can incorporate LLM-driven recommendations for content segmentation, title or caption generation, and/or content structuring (e.g., proposed hooks or transitions), based on historical performance data (e.g., associated with the first or second set of multimedia datasets and associated vector encodings) and real-time user profile attributes. In some implementations, the user interface schema and associated GUI includes indications of constraint-based editing controls (e.g., sliding scales to vary content length, language, and/or thematic focus).

The multimedia orchestration platform can generate, via the multimedia analytics engine 116 and the GUI configuration engine 118, visualizations (e.g., interactive or otherwise) of previous engagement metric values (e.g., associated with previously published or transmitted multimedia datasets). For example, the multimedia orchestration platform 102 generates a graphical user interface at operation 320 according to the user-interface schema. As such, the multimedia orchestration platform 102 enables generation of a user interface that dynamically presents adapted options for multimedia editing, selection, and/or publication personalized to the first entity, thereby leveraging profile attributes, historical content data, and associated constraints (e.g., imposed by a third party). For example, the GUI includes a graphical representation of a script and/or storyboard for a potential multimedia dataset (e.g., associated with a popular trend as analyzed with respect to the second set of vector encodings).

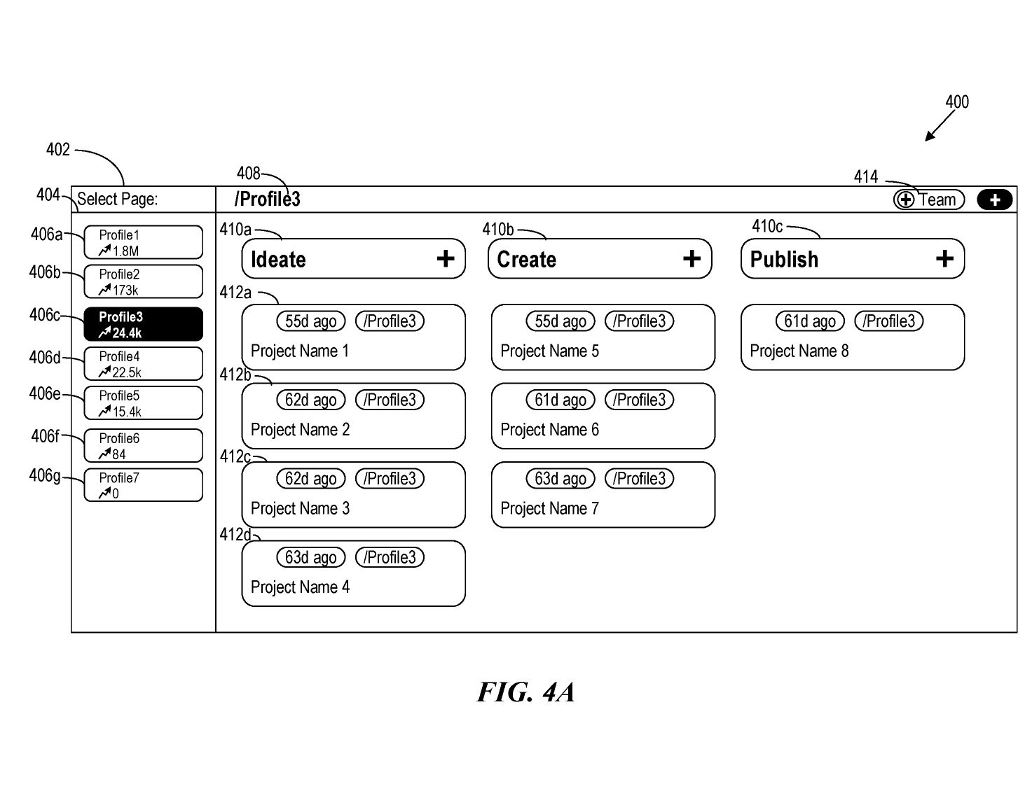

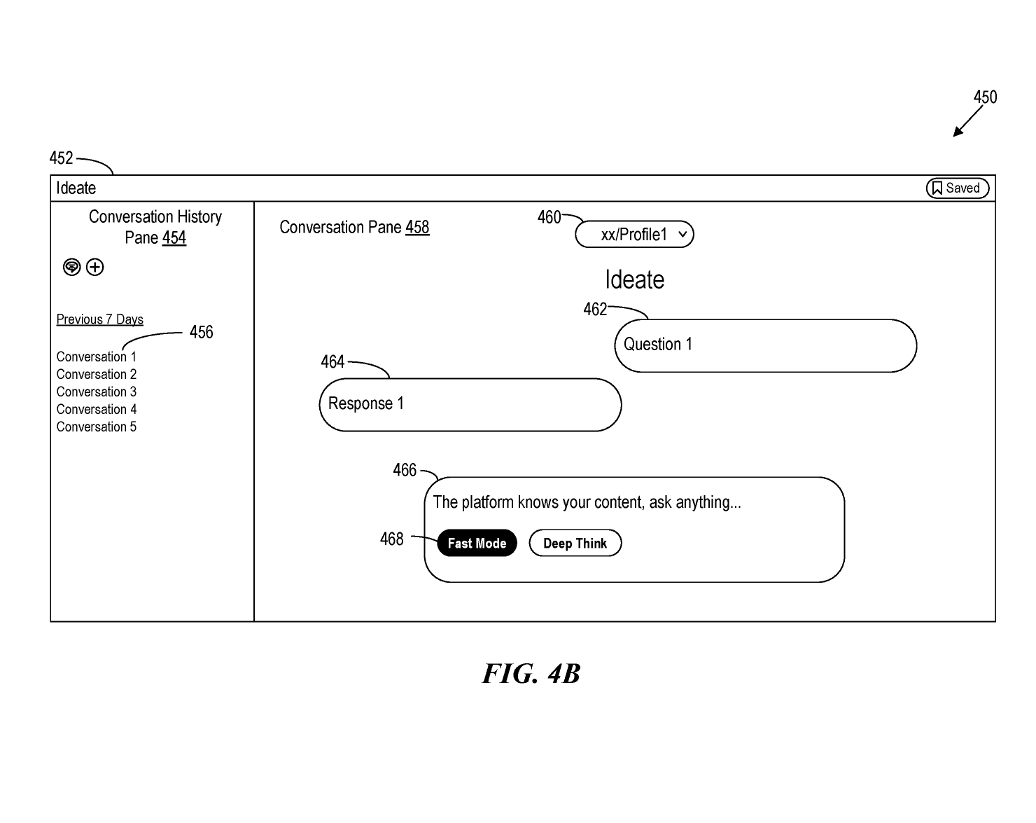

To illustrate, FIG. 4A shows a schematic 400 of a GUI 402 enabling selection of multimedia dataset templates, in accordance with one or more implementations of the disclosed technology. For example, the GUI 402 includes a page selection pane 404 that enables selection of one or more profiles (e.g., profiles 406a-406g) associated with the same entity. Upon selection (e.g., by the first entity) of a particular profile (e.g., profile 406c), the multimedia orchestration platform 102, via the GUI configuration engine 118, can generate one or more columns 410a-410c. Each column can include one or more user-interface controls (e.g., associated with particular tiles including suggestions for projects that are consistent with the constraints). For example, a first tile 412b includes and/or enables viewing of a script, storyboard, or template for a potential idea for a multimedia dataset. For example, the first tile 412b is associated with a project title and can display (e.g., upon a user interaction) a script draft, an outline of segments or scenes, a visual content plan (e.g., constructed by the large-language model 306 based on the selected profile’s metadata and applicable constraints). The tile can include actionable controls (e.g., edit, duplicate, or “send to production” buttons), enabling the user to flexibly generate multimedia dataset templates. For example, the GUI 402 includes a “Create” button associated with column 410b or a “Publish” button associated with column 410c, enabling execution of different phases in content generation. The GUI 402 can include a team functionality (e.g., associated with a user control 414) that enables one or more people to access the same set of profiles (e.g., associated with the same entity or set of entities). For example, a single brand manager can have access to one or more sets of profiles (e.g., each set of which is associated with a different entity).

For example, the multimedia orchestration platform 102 (e.g., via the GUI configuration engine 118 and/or the communication engine 112) receives an indication of a user interaction with the generated GUI. The multimedia orchestration platform 102 can receive an indication of a “click” or selection associated with a user control (e.g., a click on the tile 412b). For example, the indication of the user interaction (e.g., associated with a user interaction detection 322) includes a selection of a tile associated with a particular storyboard, script idea, and/or other attributes associated with multimedia datasets.

The multimedia orchestration platform 102 can provide the set of constraints 312, the first set of vector encodings 308, the second set of vector encodings 316, and the indication of the user interaction with the GUI to the large-language model 306 to generate a multimedia dataset template 328 that is consistent with the set of constraints and the selection of the first user control and/or indication of the user interaction (e.g., associated with the user interaction detection 322). A multimedia dataset template can include, for example, a representation of one or more multimedia attributes (e.g., a natural-language transcript, a multimedia element identifier, or a timestamp). For example, the multimedia attributes include descriptors, parameters, and/or properties associated with multimedia datasets (e.g., video, audio, text, and/or images) that provide metadata or structural information for content generation, editing, refinement, or compliance. For example, the multimedia attributes include a script, timestamp, description of attributes associated with a particular video (e.g., a duration, resolution, aspect ratio, frame rate, platform format, key scene descriptions/timestamps, setting, plot, theme, objects, etc.), audio (e.g., a transcript, language spoken, loudness, prominent keywords, background music, etc.), images (e.g., main themes, text density, logo/watermark location, color palette, contrast, etc.), and/or other suitable attributes. By generating multimedia attributes and/or other components of the multimedia dataset template, the multimedia orchestration platform 102 enables users (e.g., creators, software developers, and/or other entities) to generate multimedia data and/or associated data in a structured, streamlined manner. In some implementations, the multimedia dataset template conforms to any constraints specified by the set of constraints (e.g., received from the second entity).

In some implementations, the multimedia orchestration platform 102 generates historical and/or predicted analytics (e.g., associated with engagement metric values) within the GUI. For example, the GUI 402 can include server labels, such as platform labels that indicate a platform identifier that corresponds to a particular performance metric value. A performance metric value (e.g., an engagement metric value) can include quantitative and/or qualitative indicators, including a number of views (e.g., associated with a particular multimedia dataset and/or a variety of multimedia datasets), likes, shares, comments, downloads, audience engagement scores, sentiment analysis results, audience retention rates, click-through rates, watch times, virality scores, and/or other suitable measures reflecting user interactions, interest, and/or responses to multimedia dataset/content on a given platform. The values can be associated with particular timestamps, events, or segments within the multimedia dataset and can be used to assess and/or compare performance of content datasets across different platforms (e.g., server labels).

In some implementations, the multimedia orchestration platform 102 generates related entities associated with the first entity (e.g., to encourage and/or suggest network growth or collaborations between various entities). For example, the multimedia orchestration platform 102 provides the first set of vector encodings and the second set of vector encodings, each representing multimedia datasets associated with respective entity identifiers, to a large-language model to generate an indication of a set of related entities (e.g., that share content similarities, overlapping audience, and/or comparable performance metrics with the first entity). The multimedia orchestration platform 102 can generate a user control that is associated with a collaboration recommendation (e.g., a tile on the GUI 402 indicating a potential collaborator or associated entity) enabling generation of an associated multimedia dataset template (e.g., that suggests or includes elements, such as scripts or storyboards, enabling collaboration between the users).

Based on the generated multimedia dataset template 328, the multimedia orchestration platform 102 can obtain (e.g., via the first entity device) a multimedia dataset 330 (e.g., that is based on and/or related to the multimedia dataset template 328). For example, the multimedia dataset 330 includes a dataset generated by the first entity (e.g., via the first entity device, such as an associated camera or smartphone) that in part or fully satisfies the requirements, suggestions, and/or guidelines specified within the multimedia dataset template 328. The multimedia orchestration platform 102 can determine and/or validate (e.g., via the constraint application engine 120) whether the multimedia dataset 330 satisfies and/or is consistent with the multimedia dataset template 328 (e.g., by providing the multimedia dataset 330 and the multimedia dataset template 328 to the large-language model 306). When the multimedia orchestration platform 102 determines that the multimedia dataset 330 is inconsistent with the multimedia dataset template 328, the multimedia orchestration platform 102 can provide an updated multimedia dataset template (e.g., providing targeted feedback or corrective suggestions). In some implementations, the multimedia orchestration platform 102 generates metadata associated with the multimedia dataset 330 (e.g., captions, tags, topics, hashtags, and associated vector encodings) to enable further analytics and/or cross-platform optimization. In collaborative scenarios, the multimedia dataset 330 can include segments, annotations, and/or contributions from multiple entities.

In some implementations, the multimedia orchestration platform 102 receives additional user input during template generation. For example, the multimedia orchestration platform 102 receives (e.g., via the communication engine 112), a user prompt (e.g., a description of content attributes, objectives, and/or thematic guidance) and a preliminary multimedia dataset. The multimedia orchestration platform 102 can provide the user prompt, the representation of the preliminary multimedia dataset (e.g., thumbnails, extracted features, partial content, and/or the raw data), and a set of platform-specific and/or custom constraints, to the large-language model to generate the multimedia template in a manner that is context-sensitive (e.g., thereby enabling the multimedia orchestration platform 102 to adapt suggestions, requirements and guidelines based on the preliminary dataset, the user’s objectives, and any imposed constraints).

To illustrate, FIG. 4B shows a schematic 450 of a GUI 452 enabling tuning of multimedia dataset templates, in accordance with one or more implementations of the disclosed technology. The GUI 452 can include a conversation pane 458 enabling interactions between the user and a large-language model (e.g., the large-language model 306). The conversation pane 458 can be associated with a particular profile (e.g., controllable via a user control 460). The large-language model interface within the conversation pane 458 can include graphics that represent text (e.g., prompt(s) 462 by the first entity and/or response(s) 464 from the large-language model 306). A text box 466 enables the first entity to iterate and/or provide prompts to the large-language model. In some implementations, the multimedia orchestration platform 102 enables the first entity to select a particular large-language model (e.g., using the user control 468). In some implementations, the GUI 452 includes a conversation history pane 454 that records previous conversations 456 between the first entity and the large-language model.

In some implementations, the multimedia orchestration platform 102 can operate as an artificial intelligence agent. For example, the multimedia orchestration platform 102 receives, from the first entity device, a request for information, data, or suggestions associated with the first entity (e.g., via the text box 466 of FIG. 4B). Based on the request, the multimedia orchestration platform 102, via the large-language model, can determine one or more external sources, agents (e.g., other suitable models), or other entities with which to communicate and/or interact in order to respond to the user request. For example, based on the request for information, the multimedia orchestration platform 102 generates a search query and transmits the search query to a web search engine to retrieve information relevant to the request. Based on the retrieved information and based on the user-specific context (e.g., historical or personality data associated with the first vector encodings of the first entity), the multimedia orchestration platform can generate a response to the request for information (e.g., using the large-language model) and transmit the request to the first entity device (e.g., via the GUI 452, such as via response(s) 464).

Referring to FIG. 3, the multimedia orchestration platform 102 (e.g., via the communication engine 112) can transmit the multimedia dataset to at least one server of the set of servers (e.g., server(s) 332a-332n). For example, the communication engine 112 utilizes one or more APIs associated with each server to enable transmission of the multimedia dataset (and subsequent publication within the associated platform).

In some implementations, the multimedia orchestration platform 102 can transmit the multimedia dataset to the associated server(s) according to a schedule specified within the multimedia dataset template (e.g., at particular times associated with timestamps within the template).

Upon transmission, the multimedia orchestration platform 102 can receive a set of performance-metric values (e.g., engagement metric values) associated with the transmitted multimedia dataset (e.g., engagement, reach, and/or content compliance). The multimedia orchestration platform 102 can provide a representation of the set of constraints, the received performance-metric values, and the obtained multimedia dataset to the large-language model 306 to generate a second multimedia dataset template adapted to any new constraints and/or informed by the platform performance analytics.

In some implementations, the multimedia orchestration platform 102 generates a vector encoding (e.g., via the vector encoding engine 114) of the transmitted multimedia dataset and provides it to the large-language model, thereby enabling generation of an updated user-interface schema (e.g., including a thumbnail representing the transmitted/published multimedia dataset). For example, the updated schema includes an indication of the transmitted multimedia dataset, associated recommendations (e.g., for follow-up multimedia datasets), associated performance metric valuers (e.g., viewership data), and/or an update to themes or styles that reflect features of the dataset. The multimedia orchestration platform 102 can generate/update the GUI according to the updated user-interface schema.

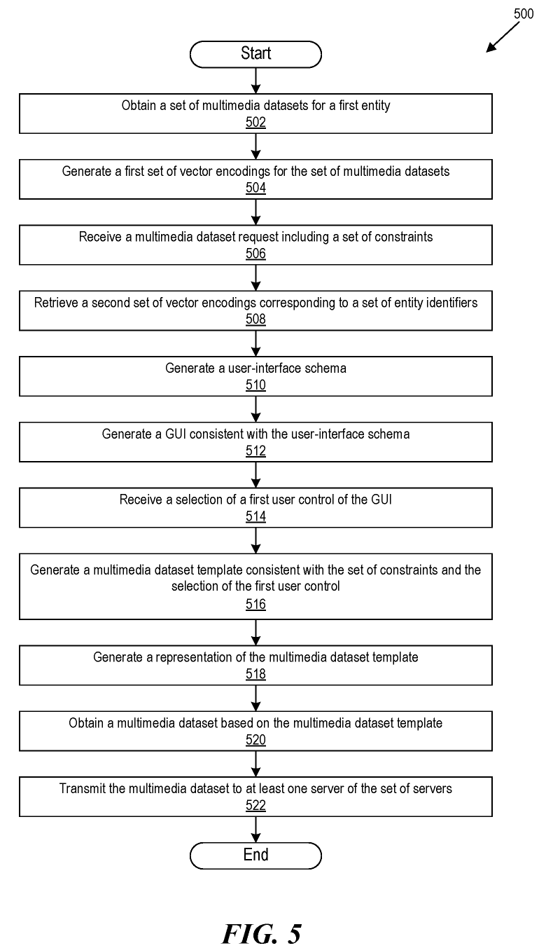

FIG. 5 shows a flow diagram illustrating a process 500 for generating a multimedia dataset template based on a user input associated with user-specific multimedia dataset analytics, in accordance with one or more implementations of the disclosed technology. The multimedia orchestration platform 102 disclosed herein enables modification of contexts associated with artificial intelligence models based on a particular user’s historical data (e.g., personality or content-related data or themes).

At 502, multimedia orchestration platform 102 obtains a set of multimedia datasets for a first entity. For example, multimedia orchestration platform 102 obtains, from one or more APIs associated with a corresponding server of a set of servers, a set of multimedia datasets relating to a first entity associated with a first entity device and with a first entity identifier. As an illustrative example, multimedia orchestration platform 102 collects videos, images, and audio clips (and/or other suitable multimedia datasets) that a content creator has uploaded to a social media platform, associated with the creator’s profile identifier (e.g., a user handle, username, and/or tag), via an API of the corresponding platform. By doing so, multimedia orchestration platform 102 can provide a centralized and automated means for aggregation of distributed multimedia datasets associated with a user (e.g., a creator) for downstream analytics and orchestration of distribution (e.g., deployment and/or publication on associated social media platforms).

At 504, multimedia orchestration platform 102 can generate the first set of vector encodings for the set of multimedia datasets. For example, multimedia orchestration platform 102 provides a representation of each multimedia dataset of the set of multimedia datasets to a large-language model to generate a first set of vector encodings for the set of multimedia datasets. In some implementations, each vector encoding of the first set of vector encodings represents, for a particular multimedia dataset of the set of multimedia datasets, at least one of: particular semantic content, a particular sentiment indicator, a particular performance indicator, a particular audio-visual feature, or a particular metadata structure. As an illustrative example, multimedia orchestration platform 102 analyzes each multimedia dataset (e.g., uploaded video, audio, and/or image) associated with a particular user (e.g., a content creator) and/or associated persona and generates a vector representation capturing relevant attributes of the multimedia dataset, such as the title, genre, sentiment, engagement metric values, and/or content themes, thereby enabling context-aware orchestration of subsequent multimedia content generation. By doing so, multimedia orchestration platform 102 enables semantic search, clustering, and fine-grained personalization of multimedia data in a unified data format (e.g., a JSON-type file).

At 506, multimedia orchestration platform 102 can receive a multimedia dataset request including a set of constraints. For example, multimedia orchestration platform 102 receives a multimedia dataset request associated with a second entity, where the multimedia dataset request includes a request for generation of a multimedia dataset according to a set of constraints. In some implementations, the set of constraints comprises at least one of: a forbidden token dataset, a multimedia-dataset format identifier, a target entity identifier, or a performance metric identifier. As an illustrative example, multimedia orchestration platform 102 receives from a user’s advertising partner for a new advertising campaign video, specifying constraints including duration limits, platform-specific compliance rules, and/or thematic limitations associated with the particular advertising partner. By doing so, multimedia orchestration platform 102 supports workflow automation and compliance with third-party or stakeholder requirements associated with multimedia dataset generation tasks (e.g., further content creation tasks).

At 508, multimedia orchestration platform 102 can retrieve a second set of vector encodings corresponding to a set of entity identifiers. For example, in response to the multimedia dataset request, multimedia orchestration platform 102 retrieves, from a vector encoding database, a second set of vector encodings corresponding to a set of entity identifiers. Each vector encoding of the second set of vector encodings can be associated with a particular entity identifier of the set of entity identifiers. As an illustrative example, multimedia orchestration platform 102 retrieves performance metric– or attribute-rich representations of previous multimedia datasets (e.g., content) from peer users and/or competitor users for context-aware content evaluation and feedback. As such, multimedia orchestration platform 102 enables data-driven suggestions for users (e.g., entities) for new content to be published, based on other users’ previously published data and associated performance metrics.

At 510, multimedia orchestration platform 102 can generate a user-interface schema. For example, multimedia orchestration platform 102 provides a representation of (1) the set of constraints, (2) the first set of vector encodings, and (3) the second set of vector encodings to the large-language model to generate a user-interface schema specific to the first entity. As an illustrative example, multimedia orchestration platform 102 automatically synthesizes a template for a GUI-based dashboard, set of tiles, or workflow tailored to the user (e.g., the creator) that enables suggestions of scripts, publication times, and/or other relevant suggestions related to generating multimedia datasets, based on the user’s previously published multimedia datasets, other users’ content, and any constraints imposed by other entities, such as third parties (e.g., advertising agencies). By doing so, multimedia orchestration platform 102 can tailor the GUI to a particular creator and current social media trends or popular media formats dynamically.

In some implementations, multimedia orchestration platform 102 customizes the user-interface schema and/or associated GUI based on user profile information. For example, multimedia orchestration platform 102 retrieves, from a profile database, profile metadata including a set of profile attributes characterizing a profile associated with the first entity. Multimedia orchestration platform 102 can provide the profile metadata to the large-language model to generate the user-interface schema based on the set of profile attributes. As an illustrative example, multimedia orchestration platform 102 can retrieve profile attributes associated with the first entity (e.g., the creator/user), such as content type preferences, demographic information, audience statistics, historical engagement metrics, and/or associated information, from a profile database. Multimedia orchestration platform 102 can provide the profile attributes (e.g., the profile metadata) to the large-language model to generate the user-interface schema to suggest videos and/or other multimedia content that is sensitive to the creator’s profile, thereby adapting to the user’s individual characteristics dynamically and improving workflow efficiency and user satisfaction.

In some implementations, generating the user-interface schema includes determining a parameter value that is specific to the user and generating the schema with an indication of the parameter value. For example, the multimedia orchestration platform 102 determines, based on the first set of vector encodings and the multimedia dataset request, a first parameter value specific to the first entity and associated with the second entity. The multimedia orchestration platform 102 can generate the user-interface schema to include (1) an indication of an element associated with the multimedia dataset request and (2) the first parameter value. As an illustrative example, the multimedia orchestration platform 102 determines a price that is specific to a particular content creator (and is dependent on or related to a particular sponsor or advertiser requesting to advertise on the given content creator’s page). For example, the multimedia orchestrator platform 102 determines that a first content creator (e.g., associated with the first entity) is associated with metadata that indicates a high level of viewer engagement (e.g., a large number of likes, subscriptions, or comments on one or more associated content datasets). In response to the determination, the multimedia orchestration platform 102 generates a parameter value proportional to or otherwise mathematically related to the level of viewer engagement (e.g., indicating a price for an associated advertising campaign). The parameter value can be included in the user interface schema so as to enable the user to select the option (e.g., thereby enabling selection of a personalized payment relationship between the user and the associated advertiser).

At 512, multimedia orchestration platform 102 can generate a GUI consistent with the user-interface schema. For example, multimedia orchestration platform 102 generates, for display on the first entity device, a GUI consistent with the user-interface schema. As an illustrative example, multimedia orchestration platform 102 generates a display of a GUI with video editing controls, pre-populated tags, a pre-determined video script (e.g., for a new suggested video), and/or a publishing calendar, consistent with the user-interface schema. By doing so, multimedia orchestration platform 102 enables streamlined content creation and user input with respect to future generated multimedia.

At 514, multimedia orchestration platform 102 can receive a selection of a first user control of the GUI. For example, in response to generating the GUI, multimedia orchestration platform 102 can receive, from the first entity device, a selection of a first user control of the GUI or an indication of a user interaction at the GUI. As an illustrative example, multimedia orchestration platform 102 receives an indication of a creator clicking on a tile associated with the GUI indicating a particular multimedia format (e.g., a short-form video), as well as a preference for automatic captioning, based on the displayed options. By doing so, multimedia orchestration platform 102 can adapt the automation pipeline to the individual creator’s preferences, while incorporating trend data and user-specific information.

In some implementations, the multimedia orchestration platform 102 can interact with, operate, and/or communicate with one or more sources to generate responses to user queries (e.g., the multimedia generation request and/or other related queries). For example, the multimedia orchestration platform 102 receives a user request associated with the multimedia dataset request. The multimedia orchestration platform 102 can provide the user request to the artificial intelligence model to determine an indication of one or more sources associated with user request. The multimedia orchestration platform 102 can generate, based on the user request and the indication of the one or more sources, one or more search queries. The multimedia orchestration platform 102 can transmit the one or more search queries to the one or more sources. In response to transmitting the one or more search queries to the one or more sources, the multimedia orchestration platform 102 can receive, from the one or more sources, a query response. The multimedia orchestration platform 102 can provide the query response and the first set of vector encodings to the artificial intelligence model to generate a response to the user request specific to the first entity. The multimedia orchestration platform 102 can generate, for display on the GUI, the response to the user request. As an illustrative example, the multimedia orchestration platform can operate in an agentic manner by consulting with (e.g., communicating with) suitable sources (e.g., web-pages, other users, other creators, advertisers, third-party databases, and/or other suitable data). By leveraging such data, the multimedia orchestration platform can provide flexible, tailored, and accurate (e.g., real-time) information relating to a particular user query that is not dependent on updated training data for the underlying artificial intelligence model.

At 516, multimedia orchestration platform 102 can generate a multimedia dataset template consistent with the set of constraints and the selection of the first user control. For example, multimedia orchestration platform 102 provides a representation of (1) the selection of the first user control, (2) the set of constraints, (3) the first set of vector encodings, and (4) the second set of vector encodings to the large-language model to generate a multimedia dataset template consistent with the set of constraints and the selection of the first user control. As an illustrative example, multimedia orchestration platform 102 generates a suggested video storyboard, script, captions, and/or other suitable information (e.g., including an artificial intelligence–generated video) based on the user’s selected template, campaign goals, advertising-related constraints, and/or other associated preferences (e.g., as indicated within the set of constraints and the selection of the user interface). By doing so, multimedia orchestration platform 102 enables delivery of actionable, content-relevant templates based on real-time trends, the creator’s or creator’s persona’s social media content history, and/or other associated information, thereby improving output quality and flexibility.

In some implementations, multimedia orchestration platform 102 generates user controls (e.g., buttons or tiles) on the GUI specifying different attributes desirable for inclusion in a new video or script (e.g., a new multimedia dataset to be published). For example, multimedia orchestration platform 102 determines, using the user-interface schema, a set of user-control identifiers associated with a set of multimedia attributes. Each multimedia attribute of the set of multimedia attributes can be associated with a particular user-control identifier of the set of user-control identifiers. Multimedia orchestration platform 102 can determine that the first user control is associated with a first user-control identifier of the set of user-control identifiers. Multimedia orchestration platform 102 can determine that the first user-control identifier is associated with a first multimedia attribute of the set of multimedia attributes. Multimedia orchestration platform 102 can generate the multimedia dataset template including a representation of the first multimedia attribute. As an illustrative example, multimedia orchestration platform 102 can determine that a “caption” user control (e.g., a button on a tile within the GUI) corresponds to a “caption” multimedia attribute (e.g., associated with toggling whether to generate closed captions on an associated multimedia template). Multimedia orchestration platform 102 can generate the user interface to include the user control, detect that the user has interacted with the user control (e.g., by clicking the generated button), and generate the multimedia dataset template to include the caption in response to detecting the user interaction. By doing so, multimedia orchestration platform 102 can ensure that user preferences that are selected or indicated via interactions on the GUI are reflected in generated scripts, templates, storyboards, or other suitable multimedia dataset templates.

In some implementations, the multimedia orchestration platform 102 can provide an analytics dashboard and/or associated user controls or tiles associated with data from different platforms. For example, multimedia orchestration platform 102 determines a set of server labels associated with the first set of vector encodings and the second set of vector encodings. Each server label of the set of server labels can identify a particular server of the set of servers that is associated with one or more particular vector encodings of the first or second set of vector encodings. Multimedia orchestration platform 102 can generate the user-interface schema by providing the set of server labels to the large-language model to generate the user-interface schema including, for each server label of the set of server labels, a particular user-control identifier associated with a corresponding server of the set of servers. The particular user-control identifier can be associated with instructions to generate, for display on the first entity device, an analytics dataset associated with the corresponding server. As an illustrative example, multimedia orchestration platform 102 can associate server labels (e.g., associated with particular social media platforms) with sets of vector encodings and provide the labels to the model such that the generated user-interface schema includes corresponding user controls and analytics datasets that are platform-specific or platform-sensitive. By doing so, the first entity (e.g., a user or content creator) is presented with a unified interface that centralizes management and analytics of content published across multiple platforms in a manner that is sensitive to different contexts or conditions (e.g., trends) across the different platforms.

In some implementations, multimedia orchestration platform 102 recommends and facilitates collaborations with other entities or users (e.g., based on similarities in previous content and/or networks). For example, multimedia orchestration platform 102 provides the first set of vector encodings and the second set of vector encodings to the large-language model to generate an indication of a set of related entities associated with the first entity. Multimedia orchestration platform 102 can generate, for display on the GUI of the first entity device, a second user control associated with a collaboration recommendation with at least one related entity of the set of related entities. Multimedia orchestration platform 102 can receive, from the first entity device, a selection of the second user control. Multimedia orchestration platform 102 can provide the selection of the second user control to the large-language model to generate the multimedia dataset template associated with a collaboration between the first entity and the at least one related entity of the set of related entities. As an illustrative example, multimedia orchestration platform 102 can identify relevant entities, such as another creator, with overlapping audience demographics, and provide a collaboration recommendation user control that, upon selection, generates a collaborative content template (e.g., including a script that includes one or more entities’ speech or actions). By doing so, multimedia orchestration platform 102 enables efficient discovery and execution of collaborative content creation opportunities.

In some implementations, multimedia orchestration platform 102 can modify a user’s script and/or multimedia content to be consistent with any constraints (e.g., as imposed by advertising agencies). For example, multimedia orchestration platform 102 receives, from the first entity device and via the graphical user interface, a user prompt and a preliminary multimedia dataset. Multimedia orchestration platform 102 can provide the user prompt, a representation of the preliminary multimedia dataset, and the set of constraints to the large-language model to generate the multimedia dataset template based on the preliminary multimedia dataset and according to the user prompt and the set of constraints. As an illustrative example, multimedia orchestration platform 102 receives a user prompt (e.g., including a sample script or an initial video); based on the provided multimedia dataset and/or multimedia template, multimedia orchestration platform 102 can modify and/or refine the provided template or dataset (e.g., by editing a video) to conform to any requirements (e.g., as imposed by the advertiser or platform). By doing so, multimedia orchestration platform 102 enables enhanced creator control over content generation, while ensuring alignment between creative intent and external requirements.

At 518, multimedia orchestration platform 102 can generate a representation of the multimedia dataset template. For example, multimedia orchestration platform 102 generates, for display on the GUI of the first entity device, a representation of the multimedia dataset template including at least one of: a natural-language transcript, a multimedia element identifier, or a timestamp. As an illustrative example, multimedia orchestration platform 102 presents a video timeline (e.g., with scene-by-scene transcript suggestions, consistent with any constraints imposed by advertising partners) and/or publication timestamps associated with a suggested posting timeline for different social media platforms, thereby enabling accelerated content creation workflows while remaining tailored to the creator’s brand or image.

At 520, multimedia orchestration platform 102 can obtain a multimedia dataset based on the multimedia dataset template. For example, in response to generating the representation of the multimedia dataset template, multimedia orchestration platform 102 obtains, from the first entity device, a multimedia dataset. As an illustrative example, multimedia orchestration platform 102 can receive the creator’s finalized video or multimedia, and/or any associated edits, overlays, captions.

In some implementations, multimedia orchestration platform 102 provides feedback to creators if the obtained multimedia dataset (e.g., a video uploaded by the user) does not satisfy constraints (e.g., as imposed by an advertiser). For example, multimedia orchestration platform 102 obtains, from the first entity device, a preliminary multimedia dataset. Multimedia orchestration platform 102 can provide the multimedia dataset and the set of constraints to the large-language model to generate an indication that the preliminary multimedia dataset is inconsistent with the set of constraints. In response to generating the indication that the preliminary multimedia dataset is inconsistent with the set of constraints, multimedia orchestration platform 102 can generate the multimedia dataset template. Multimedia orchestration platform 102 can generate, for display on the GUI of the first entity device, (1) a warning that the preliminary multimedia dataset is inconsistent with the set of constraints and (2) a representation of the multimedia dataset template. Multimedia orchestration platform 102 can, in response to generating the warning and the representation of the multimedia dataset template, obtain, from the first entity device, the multimedia dataset. As an illustrative example, multimedia orchestration platform 102 receives a preliminary video and, upon determining that the video exceeds duration constraints or includes a forbidden word (e.g., not-safe-for-work content), can display a warning and a new template and/or prompt the entity (e.g., the user) for an updated video compliant with the constraints. By doing so, multimedia orchestration platform 102 enforces compliance with any outstanding requirements prior to finalization of content for publishing.

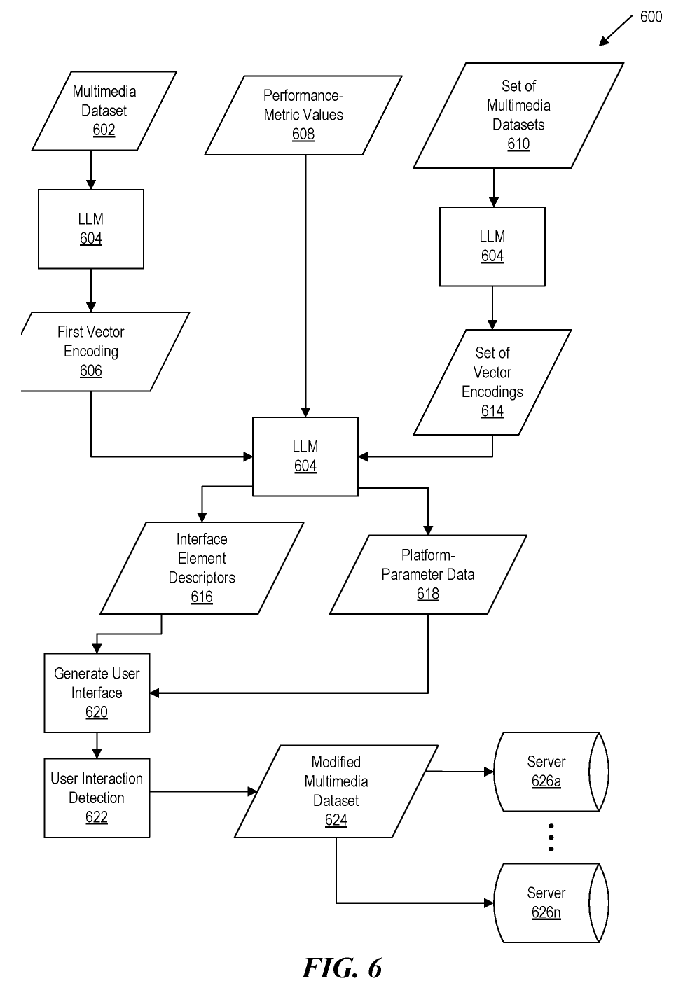

At 522, multimedia orchestration platform 102 can transmit the multimedia dataset to at least one server of the set of servers. For example, multimedia orchestration platform 102 transmits, using at least one API of the one or more APIs, the multimedia dataset to at least one server of the set of servers. As an illustrative example, multimedia orchestration platform 102 can upload the final video and/or other supporting data to a particular platform (or an associated server) according to any of the advertiser-imposed constraints and/or any user input (e.g., via interactions with the GUI). By doing so, multimedia orchestration platform 102 provides seamless, error-resistant, multi-platform publishing and associated performance/engagement tracking via multimedia orchestration platform 102 (e.g., as described with relation to FIGS. 6–8).

In some implementations, multimedia orchestration platform 102 enables scheduling of publishing (e.g., transmission to social media platforms) based on a generated schedule or timetable. For example, multimedia orchestration platform 102 generates the multimedia dataset template including a set of timestamps. Each timestamp of the set of timestamps specifies a particular scheduled time for transmitting the obtained multimedia dataset to a particular server of the at least one server of the set of servers. Multimedia orchestration platform 102 can transmit, using the at least one API of the one or more APIs, the multimedia dataset to the at least one server of the set of servers at times consistent with the timestamps of the set of timestamps. As an illustrative example, multimedia orchestration platform 102 generates transmission timestamps for a video to be uploaded to different content servers (e.g., different social media platforms) at scheduled times and automatically executes uploading operations according to the transmission timestamps. By doing so, multimedia orchestration platform 102 facilitates precise, automated publishing workflows (e.g., that optimize content delivery for target audiences).

In some implementations, multimedia orchestration platform 102 generates new multimedia templates (e.g., scripts for content) adaptively based on performance of previously published multimedia datasets. For example, multimedia orchestration platform 102 retrieves, via the at least one API of the one or more APIs, a set of performance-metric values associated with the obtained multimedia dataset to the at least one server of the set of servers. Multimedia orchestration platform 102 can receive a second multimedia dataset request associated with a third entity. The multimedia dataset request includes a second request for generation of a second multimedia dataset according to a second set of constraints. Multimedia orchestration platform 102 can provide a representation of (1) the second set of constraints, (2) the set of performance-metric values, and (3) the obtained multimedia dataset to the large-language model to generate a second multimedia dataset template consistent with the second set of constraints and based on the set of performance-metric values. As an illustrative example, multimedia orchestration platform 102 retrieves performance metrics (e.g., engagement rates, comments, numbers of “likes,” or other suitable information) after publishing a video and use the data, as well as any associated constraints, to generate a new multimedia template or dataset (e.g., follow-up content), thereby enabling iterative, data-driven enhancement of content over successive publishing cycles.

In some implementations, multimedia orchestration platform 102 enables the user to select a particular large-language model for generation of multimedia dataset templates (e.g., content templates or scripts). For example, multimedia orchestration platform 102 determine a set of available large-language models. Multimedia orchestration platform 102 can generate, for display on the GUI of the first entity device, a second user control enabling selection of large-language models of the set of available large-language models. Multimedia orchestration platform 102 can receive, from the first entity device, a selection of the large-language model of the set of available large-language models. Multimedia orchestration platform 102 can determine to generate, using the large-language model, at least one of the user-interface schema or the multimedia dataset template using the large-language model. As an illustrative example, multimedia orchestration platform 102 displays options to select among different large-language models configured or tailored to different tasks (e.g., a “deep” model, a “reasoning” model, and/or a fast, lightweight model) and utilize the selected model for GUI or content template generation. By doing so, multimedia orchestration platform 102 enables tailoring of generation processes to specific performance or content requirements.

In some implementations, multimedia orchestration platform 102 dynamically updates the user interface based on further multimedia datasets that are published (e.g., further content generated by the entity/user/creator). For example, in response to transmitting the multimedia dataset to the at least one server of the set of servers, multimedia orchestration platform 102 generates a vector encoding of the multimedia dataset. Multimedia orchestration platform 102 can provide the vector encoding of the multimedia dataset to the large-language model to generate an updated user-interface schema based on the multimedia dataset. The updated user-interface schema can include at least one of: (i) an indication of the multimedia dataset within the GUI, (ii) a reconfiguration of recommendations presented via the GUI based on the multimedia dataset, or (iii) an indication of one or more themes or styles of the GUI based on attributes of the multimedia dataset. Multimedia orchestration platform 102 can generate, for display on the first entity device, an updated GUI consistent with the updated user-interface schema. As an illustrative example, multimedia orchestration platform 102, upon publishing a video, generates a vector encoding of the video and updates (e.g., via the large-language model) the GUI to reflect the new video; based on the new video, multimedia orchestration platform 102 can provide recommendations or themes based on the content’s characteristics and/or associated engagement metrics (e.g., performance metric values). By doing so, multimedia orchestration platform 102 enables the interface and recommendations to evolve responsively with user activity and published content.

### Multimedia Orchestration Platform for Modifying Multimedia Datasets Based on Platform-Specific Metadata

FIG. 6 shows a block diagram 600 of a framework for configuring, modifying, and distributing multimedia datasets in a platform-dependent, performance-sensitive, and user input–driven data processing flow, in accordance with one or more implementations of the disclosed technology.

For example, the multimedia orchestration platform 102 (e.g., via the communication engine 112) can obtain a new multimedia dataset 602 related to a first entity device. For example, the first entity device can capture and upload a new video recording from a mobile device (e.g., corresponding to a content creator). The multimedia orchestration platform 102 can associate the uploaded data structure to a particular entity (e.g., a persona associated with the content creator and/or an affiliated user account), thereby enabling individualized tracking, processing, and analytics for each entity represented in the multimedia orchestration platform 102.

The multimedia orchestration platform 102 (e.g., via the vector encoding engine 114) can provide the multimedia dataset 602 to the large-language model 604 (e.g., large-language model 306) to generate a first vector encoding 606 associated with the multimedia dataset 602. For example, the multimedia orchestration platform 102 extracts features or attributes associated with the multimedia dataset 602 (e.g., associated text transcripts, image features, themes, styles, associated metadata, etc.) and generates the vector encoding, using the large-language model, to include a high-dimensional vector embedding capturing semantic, stylistic, and/or contextual characteristics of the multimedia dataset. As such, the generated encoding facilitates downstream tasks, including similarity searches, recommendations for other multimedia dataset generation tasks, classification tasks, and/or clustering analyses.

In some implementations, the multimedia orchestration platform 102 retrieves (e.g., via an API and via communication engine 112) a performance-metric dataset associated with a set of multimedia datasets (e.g., from or across multiple platforms). For example, the performance metric dataset includes performance metric values 608 associated with a set of multimedia datasets 610 (e.g., corresponding to a set of entities, such as entities other than the first entity and/or including the first entity). In some implementations, the performance metric dataset includes platform identifiers representing specific content-hosting platform information to enable platform-specific analytics (e.g., of differences in trends or popular content types across platforms). As an illustrative example, the performance-metric values include parameters associated with multimedia datasets of the set of multimedia datasets 610 including views, likes, engagement rates, shares, and watch time.

The multimedia orchestration platform 102 can provide representations of the set of multimedia datasets to the large-language model (e.g., the LLM 604) to generate a set of vector encodings 614. Each vector encoding can represent a particular multimedia dataset and is associated with a particular entity identifier, a particular performance-metric value, and a particular platform identifier. By generating multiple vector encodings corresponding to previously published multimedia datasets (e.g., previously published videos on various platforms and associated with various entities, users or personas), the multimedia orchestration platform 102 enables efficient organization, comparison, clustering, and analysis of multimedia datasets across multiple entities and platforms within a unified embedding space, supporting advanced analytics, recommendations, and insight generation functionalities.

In some implementations, the multimedia orchestration platform 102 can selectively generate vector encodings corresponding to multimedia datasets associated with platforms in which the user (e.g., the first entity) is active. For example, the multimedia orchestration platform 102 can determine a subset of platform identifiers (e.g., social media network names and/or associated profiles) where the user is active (e.g., associated with an active status indicator). In some implementations, the multimedia orchestration platform 102 determines the active status indicator by determining a post frequency and/or a previous post timestamp and comparing the frequency or timestamp with an associated threshold value.

The multimedia orchestration platform 102 can provide the performance metric values 608, the set of vector encodings 614, and the first vector encoding 606 to the large-language model 604 to generate a user-interface schema (e.g., as described above). For example, the user-interface schema includes a set of interface-element descriptors 616 corresponding to the set of platform identifiers and platform-parameter data 618 that characterizes performance metrics for at least one or more servers associated with platform identifiers. By integrating platform-level data and entity-specific data, the multimedia orchestration platform 102 enables generation of a user-tailored user interface that adapts interface elements and their arrangement for optimal presentation and user interactions based on platform and performance characteristics and their semantic relationships with the user’s generated multimedia dataset (e.g., based on a similarity or relevance between the multimedia dataset 602 and other multimedia datasets of the set of multimedia datasets 610). In some implementations, user controls and/or other interface elements associated with the user-interface template enable selection of one or more transmission constraints, as described below (e.g., via sliders, drop-down menus, and/or other associated user controls).

The multimedia orchestration platform 102 can generate a graphical user interface 620 in accordance with the user-interface schema. For example, the GUI includes the set of interface elements (e.g., including dashboard widgets, analytic charts, and/or content lists) and associated platform-parameter data.

Interface element descriptors can include structured data structures specifying the type, presentation, and/or logical function of interface elements associated with the graphical user interface. For example, an interface element descriptor specifies the element type (e.g., an analytics tile, a platform selector, a content timeline, a performance-metric graph, a publish button, a sentiment slider, etc.), the associated platform identifier, and/or configuration parameters (e.g., a display label, a position on the GUI, a tooltip text label, and/or event handler definitions). For example, an interface element descriptor associated with a graph tile defines a chart type (e.g., a time-series of engagement data associated with a particular multimedia dataset, a particular platform, or a particular multimedia dataset on a particular platform), reference a dataset of engagement values linked to a particular platform, and/or indicate interactive options for filtering by date range and/or content category.

Platform-parameter data can include processed, analyzed, and/or visually organized data characterizing performance metric data (e.g., at an aggregated level). For example, platform-parameter data includes statistical summaries (e.g., a total view count, median watch time, audience retention rate, and/or sentiment scores for multimedia datasets), and/or other performance metric values as described above. In some implementations, the platform-parameter data is associated with and/or resolved with respect to different platforms. The data can be organized into aggregate metrics (e.g., average audience engagement over a past week for a given video or set of videos), comparative analytics (e.g., a percentage increase in likes on one platform with respect to another), and/or compliance indicators (e.g., indications of content flagged by a platform for a policy violation). The platform-parameter data can encode temporal trends, audience demographic breakdowns, and/or conversion rates from user interactions. For example, a visual dashboard displays a stacked bar chart comparing weekly engagement rates across various platforms.

In some implementations, the multimedia orchestration platform 102 determines entity identifiers based on the multimedia datasets that can be associated as possible associated entities (e.g., to enable recommendations of collaborations). For example, the multimedia orchestration platform 102 can generate a user interface schema including clickable icons associated with other creators with content (e.g., datasets) that are similar to the first entity’s uploaded new multimedia dataset, thereby enabling network formation. For example, when the user selects one or more recommended entities, the multimedia orchestration platform 102 can link the new multimedia dataset to the selective entities (e.g., by suggesting the multimedia dataset to the recommended entities on corresponding GUIs on corresponding entity devices), thereby facilitating network creation and dissemination of multimedia datasets to interested or relevant entities.

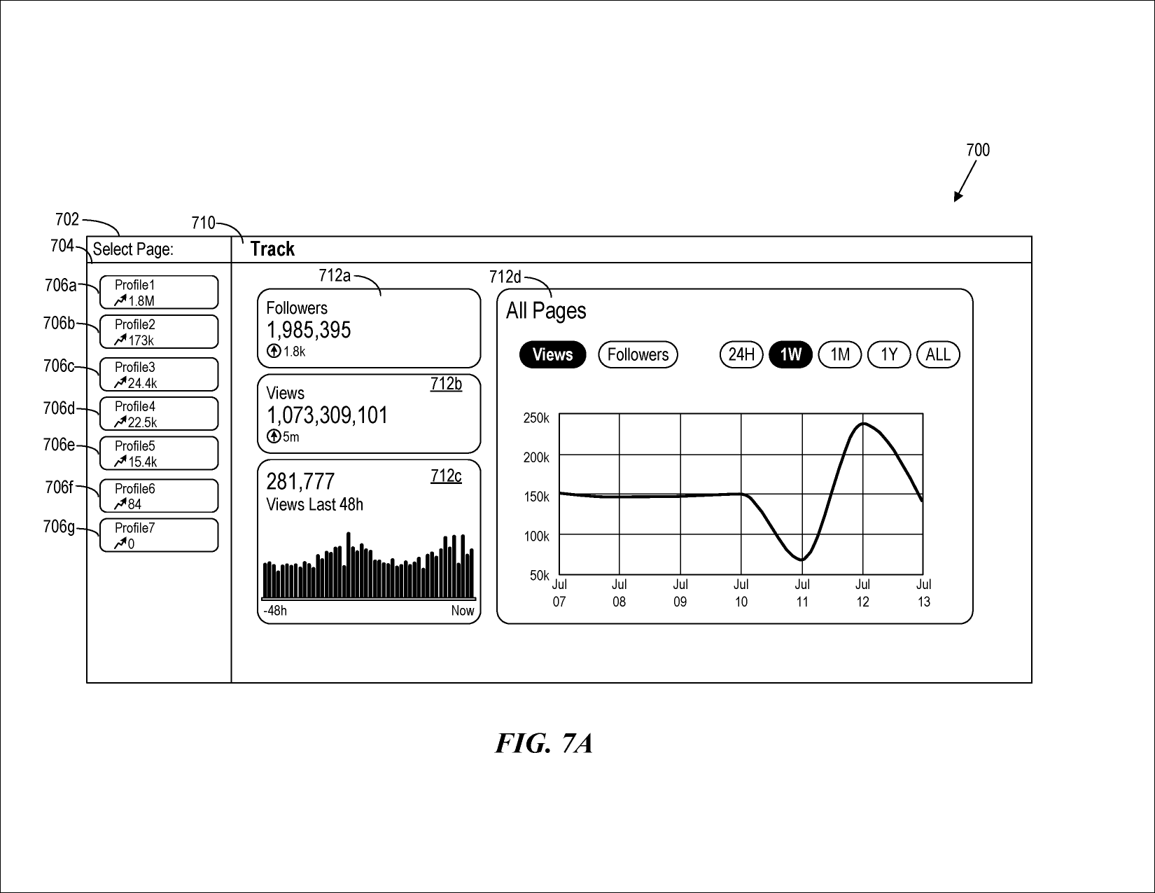

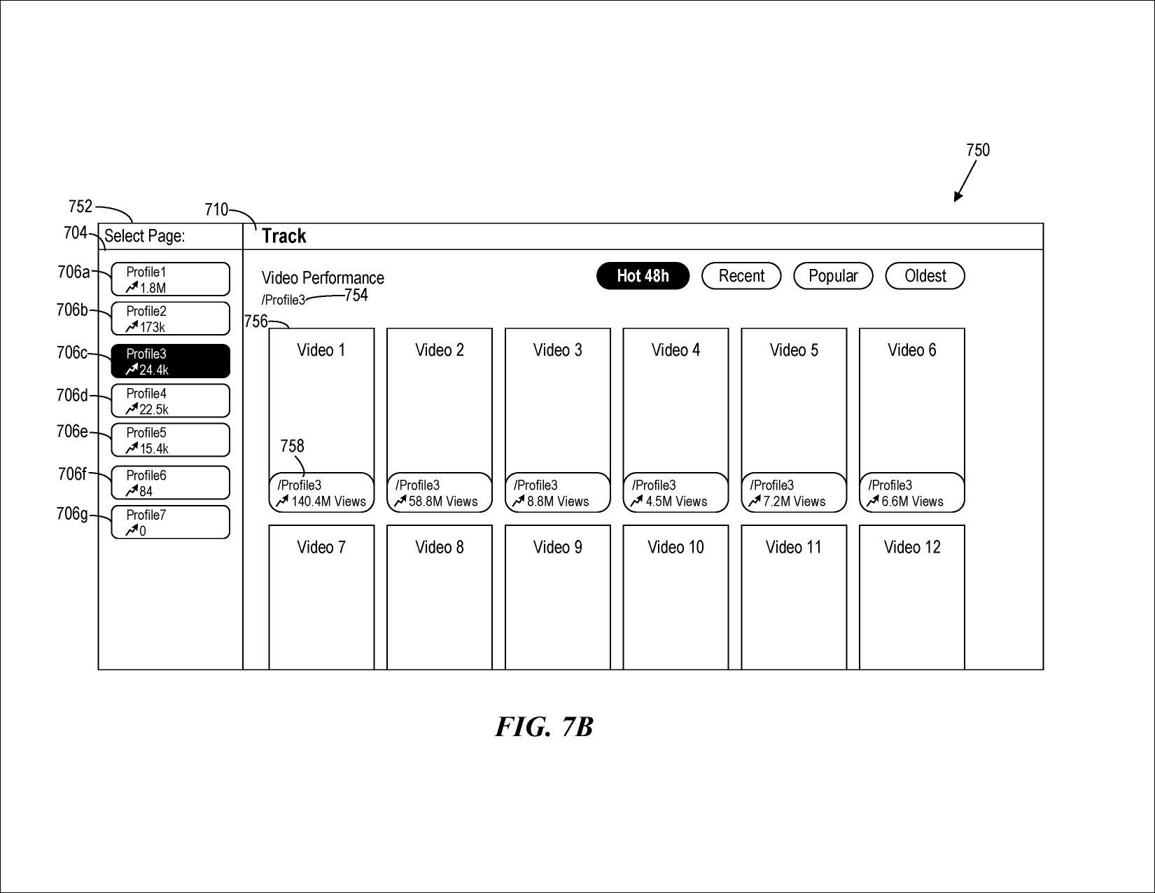

FIG. 7A shows a schematic 700 of a GUI 702 enabling display of and interaction with performance metric data associated with platform-specific and/or entity-specific multimedia datasets, in accordance with one or more implementations of the disclosed technology. For example, the GUI 702 includes a page selection pane 704 that enables selection of one or more profiles 706a-706b (e.g., personas) associated with a particular entity (e.g., creator). The multimedia orchestration platform 102 can include a tracking pane 710 that enables generation of interface elements (e.g., elements 712a-712d) that enable display of associated platform-parameter data.

FIG. 7B shows a schematic 750 of a GUI 752 enabling multimedia dataset–level display and interaction with entity-specific analytics, in accordance with one or more implementations of the disclosed technology. For example, the tracking pane 710 includes profile-specific and/or platform-specific data. For example, the GUI 752 (e.g., within the tracking pane 710) includes a thumbnail 756 corresponding to a previously published multimedia dataset and an associated platform-parameter data point 758 (e.g., indicating a number of views associated with the previously published multimedia dataset). In some implementations, user controls enable tailoring of viewable statistics (e.g., via a “Hot 48h,” “Recent,” “Popular,” and/or “Oldest” button).

The multimedia orchestration platform 102 (e.g., via the GUI configuration engine 118 and/or the communication engine 112) can receive an indication of a user interaction associated with one or more interface elements. For example, the received indication is associated with one or more transmission constraints for the new multimedia dataset. For example, based on the set of vector encodings (and/or associated performance-metric data encoded therein), the multimedia orchestration platform 102 can determine one or more transmission constraints that include suggestions, constraints (e.g., scheduling parameters), platform format requirements or suggestions (e.g., associated with particular platforms), privacy settings, and/or content compliance rules. The transmission constraints can be based on trends, analytics, and/or patterns in previously published content (e.g., multimedia datasets) that are successful (e.g., associated with positive performance metric values). For example, a transmission constraint can include an indication that a multimedia dataset corresponding to a video published in a particular platform should be associated with a duration of less than a particular length based on analytics associated with other published videos on the particular platform.

The multimedia orchestration platform 102 can determine to modify the multimedia dataset to generate a modified multimedia dataset 624 based on the determined transmission constraints. For example, the multimedia orchestration platform 102 (e.g., using constraint application engine 120) can modify the multimedia dataset in accordance with the one or more transmission constraints received via a user interaction. For example, the multimedia orchestration platform 102 can crop, resize, transcode, and/or annotate the multimedia dataset to ensure compatibility with requirements, suggestions, and/or trends associated with selected target platforms and/or any user-specified publication parameters.

In some implementations, the multimedia orchestration platform 102 modifies the multimedia dataset by removing (e.g., editing out) any forbidden elements as defined by at least one transmission constraint. For example, the multimedia orchestration platform 102 identifies a forbidden element (e.g., a prohibited image, explicit audio content, unauthorized metadata, etc.) and generates a modified multimedia dataset where each forbidden element is removed, redacted, and/or altered. When a video includes a forbidden element, the multimedia orchestration platform 102 can generate an edited video (e.g., using a generative artificial intelligence model) to remove the forbidden element from corresponding video frames.

In some implementations, the multimedia orchestration platform 102 modifies the multimedia dataset in a platform-dependent manner and/or a profile-dependent manner. For example, the multimedia orchestration platform 102 can determine forbidden elements (and/or other associated transmission constraints) specific to a particular platform or profile and generate a modified multimedia dataset for each platform or profile to which the dataset is to be transmitted, where each modified multimedia dataset is configured according to the specific platform-specific transmission constraints. As an illustrative example, a particular platform can include a constraint relating to a particular video format or codec to be used. The multimedia orchestration platform 102 (e.g., via the constraint application engine 120) can generate a modified multimedia dataset consistent with the constraint.

In some implementations, the multimedia orchestration platform 102 can determine that the one or more transmission constraints include compliance requirements (e.g., a set of constraints) associated with advertisers (e.g., as described with respect to FIG. 3) and can modify the multimedia dataset accordingly (e.g., to conform to the set of constraints). In some implementations, the multimedia orchestration platform 102 can determine that a particular transmission constraint is associated with a request and/or requirement for closed-captioning (e.g., indicating one or more particular languages). The multimedia orchestration platform 102 can provide the representation of the new multimedia dataset and the one or more transmission constraints (e.g., including the closed-captioning request) to the large-language model to generate a set of closed-captioning data structures (e.g., including a script and/or associated timestamps associated with closed-captioning). The multimedia orchestration platform 102 can modify the multimedia dataset (e.g., a video) to include the generated closed captioning.

In response to the indication of the user interaction and after applying the constraints (e.g., by modifying the multimedia dataset accordingly), the multimedia orchestration platform 102 (e.g., via the communication engine 112) can transmit the modified multimedia dataset to one or more servers associated with suitable platforms (e.g., where the transmission is consistent with the previously specified, platform-specific transmission constraints). For example, the multimedia orchestration platform 102 utilizes platform-specific APIs to ensure publication, scheduling, and/or delivery of the multimedia dataset across different platforms.

In some implementations, the multimedia orchestration platform 102 enables other users (e.g., other entities) to access one or more videos (e.g., via links and/or via thumbnails, embedded videos, etc.) associated with the first entity. For example, the multimedia orchestration platform 102 generates a GUI on a second entity device displaying visual representations of multimedia datasets linked to the first entity identifier and their associated platforms. Upon selection of a visual representation, the multimedia orchestration platform 102 can identify and transmit the corresponding URL to the second entity device, thereby enabling access to the chosen multimedia dataset. Additionally or alternatively, the multimedia orchestration platform 102 enables hosting of the associated multimedia dataset within the GUI.

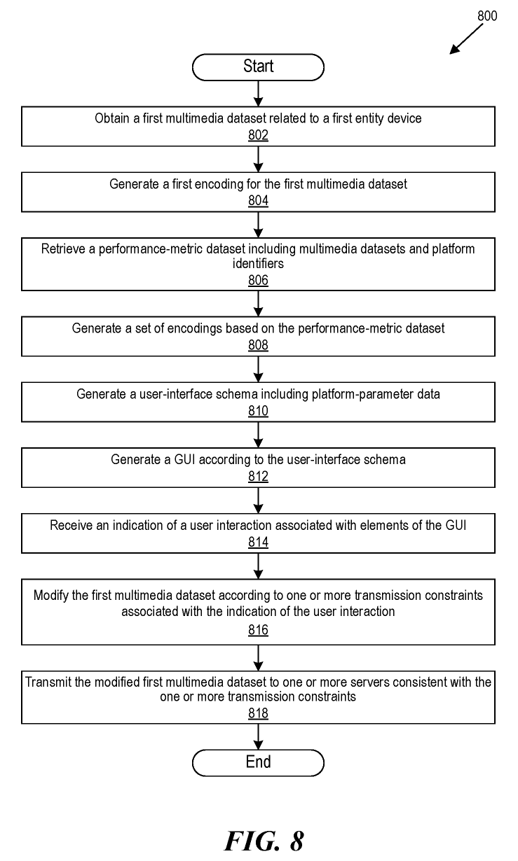

FIG. 8 shows a flow diagram illustrating a process for configuring and modifying a multimedia dataset based on performance metric– and user-based analytics for distinct platforms or servers, in accordance with one or more implementations of the disclosed technology.

At 802, multimedia orchestration platform 102 can obtain a first multimedia dataset related to a first entity device. For example, multimedia orchestration platform 102 obtains a new multimedia dataset related to a first entity device associated with a first entity identifier of a set of entity identifiers. The first entity identifier of the set of entity identifiers can correspond to a particular user device of a set of user devices or a particular profile of a set of user profiles. As an illustrative example, multimedia orchestration platform 102 receives a newly uploaded video file from a creator’s mobile device and associates the video with the creator’s profile identifier. By doing so, the system ensures received content is attributed to the relevant entity (e.g., content creator or user).

At 804, multimedia orchestration platform 102 can generate a first encoding for the first multimedia dataset. For example, multimedia orchestration platform 102 provides a representation of the new multimedia dataset to a large-language model to generate a first vector encoding for the new multimedia dataset. As an illustrative example, multimedia orchestration platform 102 can provide a creator’s newly uploaded video to the large-language model (e.g., as described with respect to FIG. 2) to output a semantic vector representing themes, attributes, and/or other suitable data associated with the video. By doing so, multimedia orchestration platform 102 enables rapid, context-aware retrieval and analytics of content through advanced vector searching and clustering.

At 806, multimedia orchestration platform 102 can retrieve a performance-metric dataset, including multimedia datasets and associated platform identifiers. For example, multimedia orchestration platform 102 retrieves, based on one or more application programming interfaces (APIs) associated with a set of servers, a performance-metric dataset comprising (1) a set of multimedia datasets, (2) a set of performance-metric values associated with the set of multimedia datasets, and (3) a set of platform identifiers associated with the set of multimedia datasets and the set of performance-metric values. Each platform identifier of the set of platform identifiers can be associated with a particular data-hosting device of the set of servers. As an illustrative example, multimedia orchestration platform 102 can query application programming interfaces associated with particular platforms to retrieve engagement metric values associated with multimedia datasets (e.g., videos, posts, stories, etc.) associated with the particular platforms. By doing so, multimedia orchestration platform 102 enables retrieval of recent, cross-platform performance metrics to support data-driven refinement of content creation (e.g., based on platform-specific trends, audiences, and predicted engagement values).

At 808, multimedia orchestration platform 102 can generate vector encodings corresponding to the retrieved multimedia datasets and performance metrics. For example, multimedia orchestration platform 102 provides a representation of the set of multimedia datasets to the large-language model to generate a set of vector encodings. Each vector encoding of the set of vector encodings can represent a particular multimedia dataset of the set of multimedia datasets. The particular multimedia dataset can be associated with a particular entity identifier of the set of entity identifiers, with a particular performance-metric value of the set of performance-metric values, and with a particular platform identifier of the set of platform identifiers. As an illustrative example, multimedia orchestration platform 102 can generate vector encodings, via the large-language model, that encode or encapsulate a video’s content (e.g., subject matter), themes, styles, and/or associated performance metric values (e.g., engagement metric values associated with fans, viewers, or other entities interacting with the content). By doing so, multimedia orchestration platform 102 enables high-dimensional mapping of heterogeneous content styles for similarity analysis, trend detection, and targeted recommendations associated with content creation.

In some implementations, multimedia orchestration platform 102 can determine platforms on which the user is active and retrieve personalized, platform-specific data from the determined platforms. For example, multimedia orchestration platform 102 determines, for the first entity identifier, a subset of platform identifiers of the set of platform identifiers. Each platform associated with each platform identifier of the subset of platform identifiers can correspond to an active status indicator for a first entity associated with the first entity identifier. Multimedia orchestration platform 102 can retrieve, via one or more APIs associated with each platform identifier of the subset of platform identifiers, a set of entity-specific multimedia datasets associated with the first entity identifier. Multimedia orchestration platform 102 can provide a representation of each multimedia dataset of the set of entity-specific multimedia datasets to the large-language model to generate a set of entity-specific vector encodings. Multimedia orchestration platform 102 can generate the set of vector encodings comprising the set of entity-specific vector encodings. As an illustrative example, multimedia orchestration platform 102 can identify that the creator is active on a particular platform, retrieve respective content uploaded by the creator based on the respective APIs, and submit the uploads to the LLM for vectorization to enable analytics based on platforms on which the creator is active.

At 810, multimedia orchestration platform 102 can generate a user-interface schema including platform-parameter data. For example, multimedia orchestration platform 102 provides the performance-metric dataset, the set of vector encodings, and the first vector encoding to the large-language model to generate a user-interface schema comprising (1) a set of interface-element descriptors corresponding to the set of platform identifiers and (2) platform-parameter data characterizing performance metrics, based on the set of performance-metric values, for at least one or more servers associated with the set of platform identifiers. As an illustrative example, multimedia orchestration platform 102 generates a graphical user interface tailored to display analytics associated with current trends that are relevant to the uploaded multimedia dataset (e.g., a new uploaded video by the content creator) and are platform-specific, thereby improving the content creator’s potential engagement statistics and publishing decisions.

In some implementations, multimedia orchestration platform 102 can recommend entities for collaborations or network-building based on the new multimedia dataset and/or the first entity identifier. For example, multimedia orchestration platform 102 provides at least a portion of the performance-metric dataset (and/or the new multimedia dataset or entity-specific information), including the set of multimedia datasets, and the set of entity identifiers to the large-language model to generate a set of recommended entity identifiers of the set of entity identifiers. The set of recommended entity identifiers can be based on the set of multimedia datasets. Each multimedia dataset of the set of multimedia datasets can be associated with a particular entity of the set of entity identifiers. Multimedia orchestration platform 102 can generate, for display on the GUI of the first entity device, a graphical representation of the set of recommended entity identifiers as selectable interface elements. The multimedia orchestration platform 102 can receive, from the first entity device, a selection of at least one selectable interface element corresponding to a selected entity identifier of the set of recommended entity identifiers. In response to the selection of the at least one selectable interface element, the multimedia orchestration platform 102 can generate an indication of an association between the new multimedia dataset and the selected entity identifier. As an illustrative example, the multimedia orchestration platform 102 analyzes recent video engagement metrics for a particular creator and uses a large-language model to recommend collaborators based on high-overlap audiences. For example, the multimedia orchestration platform 102 can cause display of suggested creators as clickable profiles on the GUI. By doing so, the multimedia orchestration platform 102 enables notification of collaboration opportunities and network-building for the creator.

At 812, multimedia orchestration platform 102 generates a GUI according to the user-interface schema. For example, multimedia orchestration platform 102 generates, for display on the first entity device, a graphical user interface (GUI) according to the user-interface schema. The graphical user interface can include a set of interface elements consistent with the set of interface-element descriptors. The graphical user interface can include a representation of the platform-parameter data. As an illustrative example, multimedia orchestration platform 102 can generate a display of a dashboard (e.g., including tiles, buttons, drop-down menus or other suitable user controls) displaying historical performance data, analytics associated with platforms, and/or potential modification suggestions associated with the uploaded video. For example, multimedia orchestration platform 102 can include possible requirements, suggestions, or constraints to apply to a content creator’s uploaded video depending on historical trends or associated engagement data associated with similar content. By doing so, multimedia orchestration platform 102 enables creators to assess predicted performance and/or trends in the community based on displayed performance-related, user-tailored, and content-tailored data.

At 814, multimedia orchestration platform 102 can receive an indication of a user interaction associated with elements of the GUI. For example, in response to generating the graphical user interface, multimedia orchestration platform 102 receives, from the first entity device, an indication of a user interaction associated with one or more interface elements of the set of interface elements. The indication of the user interaction can be associated with one or more transmission constraints associated with the new multimedia dataset. As an illustrative example, multimedia orchestration platform 102 enables the creator to interact with the GUI to select a particular platform and associated attributes (e.g., constraints with respect to publishing the new multimedia dataset on the selected platform, such as a maximum video length) using the user interface. By doing so, multimedia orchestration platform 102 enables user- and analytics-driven publication of the new multimedia dataset while conforming to any constraints, modifications, or edits associated with the platform, the user, and/or the persona.

At 816, multimedia orchestration platform 102 can modify the first multimedia dataset in accordance with the transmission constraints associated with the indication of the user interaction. For example, multimedia orchestration platform 102 modifies the new multimedia dataset in accordance with the one or more transmission constraints. As an illustrative example, multimedia orchestration platform 102 edits the multimedia dataset (e.g., by trimming a video length or adding associated captioning) as specified by the creator’s selected option on the GUI (e.g., and/or according to any platform-specific publication requirements). By doing so, multimedia orchestration platform 102 ensures compliance with destination platform requirements and user preferences, as informed by historical content creation and engagement data.

In some implementations, multimedia orchestration platform 102 can remove forbidden elements from the obtained multimedia dataset and removes the forbidden element accordingly. For example, the multimedia orchestration platform 102 determines that a first transmission constraint of the one or more transmission constraints includes an indication of a forbidden element. The multimedia orchestration platform 102 can determine that the new multimedia dataset includes the forbidden element. The multimedia orchestration platform 102, in response to determining that the new multimedia dataset includes the forbidden element, can generate the modified new multimedia dataset to remove the forbidden element. As an illustrative example, the multimedia orchestration platform 102 can detect that a video (e.g., corresponding to the new multimedia dataset) includes copyrighted music, a forbidden element associated with a transmission constraint selected by the user, and can automatically remove the copyrighted music prior to publishing. By doing so, the multimedia orchestration platform 102 can automatically ensure compliance with any selected or determined constraints (e.g., transmission constraints) to meet platform/legal requirements or suggestions.

In some implementations, multimedia orchestration platform 102 can determine that constraints of the transmission constraints are platform-specific and apply the constraints to the new multimedia dataset accordingly. For example, the multimedia orchestration platform 102 determines, for a first platform identifier of the set of platform identifiers and based on the one or more transmission constraints, a set of platform-specific forbidden elements. The multimedia orchestration platform 102 can determine that the new multimedia dataset includes at least one platform-specific forbidden element of the set of platform-specific forbidden elements. In response to determining that the new multimedia dataset includes at least one platform-specific forbidden element of the set of platform-specific forbidden elements, the multimedia orchestration platform 102 can generate the modified new multimedia dataset by editing the new multimedia dataset to remove each forbidden element of the set of platform-specific forbidden elements. As an illustrative example, the multimedia orchestration platform 102 determines constraints for generating a video and transmitting the video to a particular platform (e.g., based on platform-specific requirements or platform-specific engagement analytics or trends). For example, the multimedia orchestration platform 102 can determine that videos that are longer than a particular elapsed time are not popular on a particular platform and trim the video accordingly for the particular platform, while avoiding trimming the video for other platforms without such a constraint. By doing so, the multimedia orchestration platform 102 enables platform-specific modifications to multimedia datasets.

In some implementations, multimedia orchestration platform 102 can display and enable selection of different constraints for different personas (e.g., different user accounts) associated with the same entity. For example, the multimedia orchestration platform 102 can determine that the first entity identifier is associated with a set of profiles. Each profile of the set of profiles can correspond to a different persona. In response to determining that the first entity identifier is associated with the set of profiles, the multimedia orchestration platform 102 can generate, for display on the GUI of the first entity device, a graphical representation of the set of profiles. The multimedia orchestration platform 102 can receive, from the first entity device, the indication of the user interaction. The indication of the user interaction can include a selection of a first profile of the set of profiles. The multimedia orchestration platform 102 can determine, based on the selection of the first profile, the one or more transmission constraints particular to the first profile. The multimedia orchestration platform 102 can modify the new multimedia dataset in accordance with the one or more transmission constraints particular to the first profile. As an illustrative example, the multimedia orchestration platform 102 can enable the creator to select between an “educational” and a “comedy” persona (e.g., two separate accounts on the same platform or on different platforms), thereby prompting the system to apply particular transmission constraints to videos published on one platform but not the other. For example, the multimedia orchestration platform 102 applies family-friendly constraints (e.g., a constraint specifying that not-safe-for-work words be silenced) for the video to be sent to an educational profile, while retaining the same words for the comedy profile. By doing so, the multimedia orchestration platform 102 enables tailoring of multimedia datasets published with respect to different platforms (e.g., intended for different audiences).

In some implementations, multimedia orchestration platform 102 can apply constraints associated with advertising requirements or other similar constraints (e.g., associated with the set of constraints) associated with particular platforms. For example, multimedia orchestration platform 102 obtains, from at least one application programming interface (API) associated with a first platform identifier, a set of content compliance requirements applicable to the new multimedia dataset. The multimedia orchestration platform 102 can generate the one or more transmission constraints including the set of content compliance requirements. The multimedia orchestration platform 102 can modify the new multimedia dataset in accordance with the set of content compliance requirements. As an illustrative example, the multimedia orchestration platform 102 queries an API (e.g., associated with a particular platform) for compliance requirements (e.g., associated with video duration, forbidden keywords, video-codec requirements, or community standards) and enables enforcement of corresponding transmission constraints. By doing so, the multimedia orchestration platform 102 enables the platform to dynamically adapt to evolving platform constraints.

In some implementations, multimedia orchestration platform 102 can generate closed-captioning data structures based on determining a corresponding transmission constraint. For example, the multimedia orchestration platform 102 determines that the one or more transmission constraints include an indication of one or more languages for closed-captioning. The multimedia orchestration platform 102 can provide a representation of the new multimedia dataset and the one or more transmission constraints to the large-language model to generate a set of closed-caption data structures. Each closed-caption data structure can include particular closed-captioning data in a particular language of the one or more languages. The multimedia orchestration platform 102 can modify the new multimedia dataset to include the set of closed-caption data structures. As an illustrative example, the multimedia orchestration platform 102 can determine that the creator has selected a user control of the GUI associated with automatic closed-captioning in English and Spanish. The multimedia orchestration platform 102 can, accordingly, generate a script of closed-captioning tokens for packaging with an associated video prior to distribution to the associated platform(s). By doing so, the multimedia orchestration platform 102 enables automated video editing based on user input.

At 818, multimedia orchestration platform 102 transmits the modified first multimedia dataset to one or more servers consistent with the one or more transmission constraints. For example, in response to receiving the indication of the user interaction, the multimedia orchestration platform 102 transmits the modified new multimedia dataset to one or more servers, consistent with the one or more transmission constraints. As an illustrative example, multimedia orchestration platform 102 can cause the modified multimedia dataset (e.g., the trimmed video) to associated platforms (e.g., via the platform’s APIs), according to any scheduled times associated with the constraints. By doing so, the multimedia orchestration platform 102 enables multi-platform content distribution, minimizing creator workload and ensuring satisfaction of technical or creative constraints with respect to the published multimedia datasets.

In some implementations, the multimedia orchestration platform 102 schedules publishing tasks according to selected or determined transmission constraints (e.g., associated with different platform). For example, the multimedia orchestration platform 102 generates, based on the indication of the user interaction, the one or more transmission constraints including a publication timestamp specifying a scheduled time for transmitting the modified new multimedia dataset to the one or more servers. The multimedia orchestration platform 102 can transmit the modified new multimedia dataset to the one or more servers at the scheduled time of the publication timestamp. As an illustrative example, the multimedia orchestration platform 102 enables the creator and/or the platform to suggest or specify publication times for each platform. The multimedia orchestration platform 102 can encode the publication times as a constraint, thereby enabling transmission of the modified multimedia dataset to an associated platform according to the requested publication times, thereby supporting timing for audience optimization.

In some implementations, the multimedia orchestration platform 102 determines the publication timestamp based on a confidence value associated with historical data for the entity. For example, the multimedia orchestration platform 102 provides the indication of the user interaction, the set of encodings, and the publication timestamp to the artificial intelligence model to determine a publication confidence value for the publication timestamp. The multimedia orchestration platform 102 can determine that the publication confidence value is greater than a threshold publication confidence value. In response to determining that the publication confidence value is greater than the threshold publication confidence value, The multimedia orchestration platform 102 can generate the one or more transmission constraints including the publication timestamp. As an illustrative example, the multimedia orchestration platform 102 can determine that a particular time is likely to be associated with a high level of engagement (e.g., morning, night, afternoon, and/or other suitable indications of times or time ranges). By doing so, the multimedia orchestration platform 102 can enable scheduling of content that is published with the highest likelihood of engagement (e.g., according to advertiser-imposed transmission constraints or platform-related constraints).

In some implementations, the multimedia orchestration platform 102 enables third-parties (e.g., other users) to view and/or interact with multimedia content generated by or associated with the first entity. For example, the multimedia orchestration platform 102 generates, for display on a second entity device associated with a second entity identifier, a second GUI including a set of visual representations of a subset of multimedia datasets. The subset of multimedia datasets can include multimedia datasets of the set of multimedia datasets that are associated with the first entity identifier. Each multimedia dataset of the subset of multimedia datasets can be associated with an associated platform identifier of the set of platform identifiers. Each visual representation of the set of visual representations can correspond to an associated multimedia dataset of the subset of multimedia datasets. The multimedia orchestration platform 102 can receive, from the second entity device, a selection of a first visual representation of the set of visual representations. The multimedia orchestration platform 102 can determine a uniform resource locator (URL) associated with a first multimedia dataset associated with the first visual representation. In response to receiving the selection of the first visual representation, the multimedia orchestration platform 102 can transmit the uniform resource locator (URL) to the second entity device to enable the second entity device to access the first multimedia dataset. As an illustrative example, the multimedia orchestration platform 102 can aggregate creator’s multimedia datasets from multiple platforms and generate a unified catalogue (e.g., including thumbnails of different videos associated with the entity and/or particular persona) within a centralized GUI accessible to viewers via one or more persistent links. By doing so, the multimedia orchestration platform 102 can provide other users with seamless, cross-platform access to the creator’s content through a unified interface, thereby improving accessibility to data in a manner that is dynamically synchronized with the associated platforms.

### Computer System

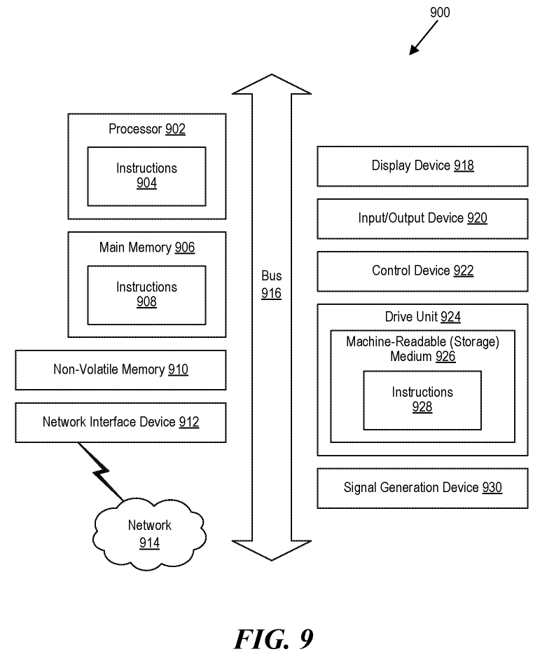

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

From the foregoing, it will be appreciated that specific embodiments of the invention have been described herein for purposes of illustration, but that various modifications may be made without deviating from the scope of the invention. Accordingly, the invention is not limited except as by the appended claims.

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. One or more non-transitory, computer-readable storage media storing instructions that, when executed by one or more processors of a computing system, cause the computing system to:
obtain, from one or more application programming interfaces (APIs) associated with a corresponding server of a set of servers, a set of multimedia datasets relating to a first entity associated with a first entity device and with a first entity identifier;
provide a representation of each multimedia dataset of the set of multimedia datasets to a large-language model to generate a first set of vector encodings for the set of multimedia datasets;
receive a multimedia dataset request associated with a second entity,
wherein the multimedia dataset request includes a request for generation of a multimedia dataset according to a set of constraints;
in response to the multimedia dataset request, retrieve, from a vector encoding database, a second set of vector encodings corresponding to a set of entity identifiers,
wherein each vector encoding of the second set of vector encodings is associated with a particular entity identifier of the set of entity identifiers;
provide a representation of (1) the set of constraints, (2) the first set of vector encodings, and (3) the second set of vector encodings to the large-language model to generate a user-interface schema specific to the first entity;
generate, for display on the first entity device, a graphical user interface (GUI) consistent with the user-interface schema;
in response to generating the GUI, receive, from the first entity device, a selection of a first user control of the GUI;
provide a representation of (1) the selection of the first user control, (2) the set of constraints, (3) the first set of vector encodings, and (4) the second set of vector encodings to the large-language model to generate a multimedia dataset template consistent with the set of constraints and the selection of the first user control;
generate, for display on the GUI of the first entity device, a representation of the multimedia dataset template including at least one of: a natural-language transcript, a multimedia element identifier, or a timestamp;
in response to generating the representation of the multimedia dataset template, obtain, from the first entity device, a multimedia dataset; and
transmit, using at least one API of the one or more APIs, the multimedia dataset to at least one server of the set of servers.

2. The one or more non-transitory, computer-readable storage media of claim 1, wherein the instructions for generating the user-interface schema cause the computing system to:
retrieve, from a profile database, profile metadata including a set of profile attributes characterizing a profile associated with the first entity; and
provide the profile metadata to the large-language model to generate the user-interface schema based on the set of profile attributes.

3. The one or more non-transitory, computer-readable storage media of claim 1, wherein the instructions for generating the representation of the multimedia dataset template cause the computing system to:
determine, using the user-interface schema, a set of user-control identifiers associated with a set of multimedia attributes,
wherein each multimedia attribute of the set of multimedia attributes is associated with a particular user-control identifier of the set of user-control identifiers;
determine that the first user control is associated with a first user-control identifier of the set of user-control identifiers;
determine that the first user-control identifier is associated with a first multimedia attribute of the set of multimedia attributes; and
generate the multimedia dataset template including a representation of the first multimedia attribute.

4. The one or more non-transitory, computer-readable storage media of claim 1, wherein the instructions for generating the multimedia dataset template cause the computing system to:
determine a set of server labels associated with the first set of vector encodings and the second set of vector encodings,
wherein each server label of the set of server labels identifies a particular server of the set of servers that is associated with one or more particular vector encodings of the first or second set of vector encodings; and
generate the user-interface schema by providing the set of server labels to the large-language model to generate the user-interface schema including, for each server label of the set of server labels, a particular user-control identifier associated with a corresponding server of the set of servers,
wherein the particular user-control identifier is associated with instructions to generate, for display on the first entity device, an analytics dataset associated with the corresponding server.

5. The one or more non-transitory, computer-readable storage media of claim 1, wherein the instructions for obtaining the multimedia dataset cause the computing system to:
obtain, from the first entity device, a preliminary multimedia dataset;
provide the multimedia dataset and the set of constraints to the large-language model to generate an indication that the preliminary multimedia dataset is inconsistent with the set of constraints;
in response to generating the indication that the preliminary multimedia dataset is inconsistent with the set of constraints, generate the multimedia dataset template;
generate, for display on the GUI of the first entity device, (1) a warning that the preliminary multimedia dataset is inconsistent with the set of constraints and (2) a representation of the multimedia dataset template; and
in response to generating the warning and the representation of the multimedia dataset template, obtain, from the first entity device, the multimedia dataset.

6. The one or more non-transitory, computer-readable storage media of claim 1, wherein the instructions for transmitting the multimedia dataset to the at least one server of the set of servers cause the computing system to:
generate the multimedia dataset template including a set of timestamps,
wherein each timestamp of the set of timestamps specifies a particular scheduled time for transmitting the obtained multimedia dataset to a particular server of the at least one server of the set of servers; and
transmit, using the at least one API of the one or more APIs, the multimedia dataset to the at least one server of the set of servers at times consistent with the timestamps of the set of timestamps.

7. The one or more non-transitory, computer-readable storage media of claim 1, wherein the instructions for generating the multimedia dataset template cause the computing system to:
provide the first set of vector encodings and the second set of vector encodings to the large-language model to generate an indication of a set of related entities associated with the first entity;
generate, for display on the GUI of the first entity device, a second user control associated with a collaboration recommendation with at least one related entity of the set of related entities;
receive, from the first entity device, a selection of the second user control; and
provide the selection of the second user control to the large-language model to generate the multimedia dataset template associated with a collaboration between the first entity and the at least one related entity of the set of related entities.

8. The one or more non-transitory, computer-readable storage media of claim 1, wherein the instructions for generating the multimedia dataset template cause the computing system to:
receive, from the first entity device and via the graphical user interface, a user prompt and a preliminary multimedia dataset; and
provide the user prompt, a representation of the preliminary multimedia dataset, and the set of constraints to the large-language model to generate the multimedia dataset template based on the preliminary multimedia dataset and according to the user prompt and the set of constraints.

9. The one or more non-transitory, computer-readable storage media of claim 1, wherein the instructions further cause the computing system to:
retrieve, via the at least one API of the one or more APIs, a set of performance-metric values associated with the obtained multimedia dataset to the at least one server of the set of servers;
receive a second multimedia dataset request associated with a third entity,
wherein the multimedia dataset request includes a second request for generation of a second multimedia dataset according to a second set of constraints; and
provide a representation of (1) the second set of constraints, (2) the set of performance-metric values, and (3) the obtained multimedia dataset to the large-language model to generate a second multimedia dataset template consistent with the second set of constraints and based on the set of performance-metric values.

10. The one or more non-transitory, computer-readable storage media of claim 1, wherein the instructions further cause the computing system to:
determine a set of available large-language models;
generate, for display on the GUI of the first entity device, a second user control enabling selection of large-language models of the set of available large-language models;
receive, from the first entity device, a selection of the large-language model of the set of available large-language models; and
determine to generate, using the large-language model, at least one of the user-interface schema or the multimedia dataset template using the large-language model.

11. The one or more non-transitory, computer-readable storage media of claim 1, wherein the instructions further cause the computing system to:
in response to transmitting the multimedia dataset to the at least one server of the set of servers, generate a vector encoding of the multimedia dataset;
provide the vector encoding of the multimedia dataset to the large-language model to generate an updated user-interface schema based on the multimedia dataset,
wherein the updated user-interface schema includes at least one of: (i) an indication of the multimedia dataset within the GUI, (ii) a reconfiguration of recommendations presented via the GUI based on the multimedia dataset, or (iii) an indication of one or more themes or styles of the GUI based on attributes of the multimedia dataset; and
generate, for display on the first entity device, an updated GUI consistent with the updated user-interface schema.

12. A computing system comprising:
one or more processors; and
one or more non-transitory, computer-readable storage media storing instructions that, when executed by the one or more processors, cause the computing system to:
obtain, from a set of platforms, a set of multimedia datasets relating to a first entity associated with a first entity device and with a first entity identifier;
provide a representation of each multimedia dataset of the set of multimedia datasets to a large-language model to generate a first set of encodings for the set of multimedia datasets;
receive a multimedia dataset request associated with a second entity,
wherein the multimedia dataset request includes a request for generation of a multimedia dataset according to a set of constraints;
in response to the multimedia dataset request, retrieve, from a encoding database, a second set of encodings corresponding to a set of entity identifiers,
wherein each encoding of the second set of encodings is associated with a particular entity identifier of the set of entity identifiers;
provide a representation of (1) the set of constraints, (2) the first set of encodings, and (3) the second set of encodings to the large-language model to generate a user-interface schema specific to the first entity;
generate, for display on the first entity device, a graphical user interface (GUI) consistent with the user-interface schema;
in response to generating the GUI, receive, from the first entity device, a selection of a first user control of the GUI;
provide a representation of (1) the selection of the first user control, (2) the set of constraints, (3) the first set of encodings, and (4) the second set of encodings to the large-language model to generate a multimedia dataset template consistent with the set of constraints and the selection of the first user control;
generate, for display on the GUI of the first entity device, a representation of the multimedia dataset template;
in response to generating the representation of the multimedia dataset template, obtain, from the first entity device, a multimedia dataset; and
transmit the multimedia dataset to at least one platform of the set of platforms.

13. The system of claim 12, wherein the instructions for generating the user-interface schema cause the computing system to:
retrieve, from a profile database, profile metadata including a set of profile attributes characterizing a profile associated with the first entity; and
provide the profile metadata to the large-language model to generate the user-interface schema based on the set of profile attributes.

14. The system of claim 12, wherein the instructions for generating the representation of the multimedia dataset template cause the computing system to:
determine, using the user-interface schema, a set of user-control identifiers associated with a set of multimedia attributes,
wherein each multimedia attribute of the set of multimedia attributes is associated with a particular user-control identifier of the set of user-control identifiers;
determine that the first user control is associated with a first user-control identifier of the set of user-control identifiers;
determine that the first user-control identifier is associated with a first multimedia attribute of the set of multimedia attributes; and
generate the multimedia dataset template including a representation of the first multimedia attribute.

15. The system of claim 12, wherein the instructions for generating the multimedia dataset template cause the computing system to:
determine a set of platform labels associated with the first set of encodings and the second set of encodings,
wherein each platform label of the set of platform labels identifies a particular platform of the set of platforms that is associated with one or more particular encodings of the first or second set of encodings; and
generate the user-interface schema by providing the set of platform labels to the large-language model to generate the user-interface schema including, for each platform label of the set of platform labels, a particular user-control identifier associated with a corresponding platform of the set of platforms,
wherein the particular user-control identifier is associated with instructions to generate, for display on the first entity device, an analytics dataset associated with the corresponding platform.

16. The system of claim 12, wherein the instructions for obtaining the multimedia dataset cause the computing system to:
obtain, from the first entity device, a preliminary multimedia dataset;
provide the multimedia dataset and the set of constraints to the large-language model to generate an indication that the preliminary multimedia dataset is inconsistent with the set of constraints;
in response to generating the indication that the preliminary multimedia dataset is inconsistent with the set of constraints, generate the multimedia dataset template;
generate, for display on the GUI of the first entity device, (1) a warning that the preliminary multimedia dataset is inconsistent with the set of constraints and (2) a representation of the multimedia dataset template; and
in response to generating the warning and the representation of the multimedia dataset template, obtain, from the first entity device, the multimedia dataset.

17. A method comprising:
obtaining a set of multimedia datasets relating to a first entity associated with a first entity device and with a first entity identifier;
providing a representation of each multimedia dataset of the set of multimedia datasets to an artificial intelligence model to generate a first set of vector encodings for the set of multimedia datasets;
receiving a multimedia dataset request associated with a second entity,
wherein the multimedia dataset request includes a request for generation of a multimedia dataset according to a set of constraints;
in response to the multimedia dataset request, retrieving, from a vector encoding database, a second set of vector encodings corresponding to a set of entity identifiers,
wherein each vector encoding of the second set of vector encodings is associated with a particular entity identifier of the set of entity identifiers;
providing a representation of (1) the set of constraints, (2) the first set of vector encodings, and (3) the second set of vector encodings to the artificial intelligence model to generate a user-interface schema;
generating, for display on the first entity device, a graphical user interface (GUI) consistent with the user-interface schema specific to the first entity;
in response to generating the GUI, receiving, from the first entity device, an indication of an interaction with the GUI;
providing a representation of (1) the interaction with the GUI, (2) the set of constraints, (3) the first set of vector encodings, and (4) the second set of vector encodings to the artificial intelligence model to generate a multimedia dataset template consistent with the set of constraints and the indication of the interaction with the GUI;
generating, for display on the GUI of the first entity device, a representation of the multimedia dataset template;
in response to generating the representation of the multimedia dataset template, obtaining, from the first entity device, a multimedia dataset; and
transmitting the multimedia dataset for publication of the multimedia dataset on a social media platform.

18. The method of claim 17, wherein generating the user-interface schema comprises:
retrieving, from a profile database, profile metadata including a set of profile attributes characterizing a profile associated with the first entity; and
providing the profile metadata to the artificial intelligence model to generate the user-interface schema based on the set of profile attributes.

19. The method of claim 17, wherein generating the user-interface schema comprises:
determining, based on the first set of vector encodings and the multimedia dataset request, a first parameter value specific to the first entity and associated with the second entity; and
generating the user-interface schema to include (1) an indication of an element associated with the multimedia dataset request and (2) the first parameter value.

20. The method of claim 17, further comprising:
receiving a user request associated with the multimedia dataset request;
providing the user request to the artificial intelligence model to determine an indication of one or more sources associated with user request;
generating, based on the user request and the indication of the one or more sources, one or more search queries;
transmitting the one or more search queries to the one or more sources;
in response to transmitting the one or more search queries to the one or more sources, receiving, from the one or more sources, a query response;
providing the query response and the first set of vector encodings to the artificial intelligence model to generate a response to the user request specific to the first entity; and
generating, for display on the GUI, the response to the user request.
